(19) United States
(12) Patent Application Publication
(10) Pub. No.: US 2011/0032286 A1
(43) Pub. Date: Feb. 10, 2011

(54) DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/936,233

(22) PCT Filed: Mar. 19, 2009
(86) PCT No.: PCT/JP2009/055440

§ 371 Date: Oct. 4, 2010

(30) Foreign Application Priority Data
Apr. 9, 2008 (JP) 2008-101733

(51) Int. Cl. G09G 5/10

(52) U.S. Cl. 345/690

(57) ABSTRACT

A display device 10 of the present invention includes a display panel 10, a fluorescent lamp 17, a brightness controller 40 and a temperature sensor TS. The display panel 10 has a grayscale display function. The fluorescent lamp 17 emits light toward the display panel 10. The brightness controller 40 controls display brightness by adjusting the grayscale of the display panel 10 and the light emission of the fluorescent lamp 17. The temperature sensor TS measures a temperature of the display device 10. The brightness controller 40 selects a way of the brightness control from the display panel 10 grayscale adjustment, the fluorescent lamp 17 emission adjustment and a combination of both based on the temperature of the display device 10 measured by the temperature sensor TS.

### TECHNICAL FIELD

The present invention relates to a display device and a television receiver.

### BACKGROUND ART

A liquid crystal display device including a liquid crystal panel and a backlight unit that is a lighting device for illuminating the liquid crystal panel is known. When such a display device is used in a liquid crystal television receiver, a remote control system including a remote control with which a user can operate the television receiver may be provided. Remote controls using infrared rays are widely used. When the user operates the remote control for desired operations, infrared signals for transmitting control commands are sent from the remote control to the television receiver. The television receiver executes various controls including television channel changing and display brightness control according to the control commands.

The backlight unit in the liquid crystal television receiver may include a fluorescent lamp as a light source. The fluorescent lamp has a glass tube with a fluorescent material applied to an inner wall thereof. A noble gas (e.g., neon gas, argon gas) and mercury are sealed in the glass tube. When a high voltage is applied across ends of the glass tube, an electric discharge occurs and mercury vapor is excited due to collision with electrons or atoms of the sealed gas. As a result, ultraviolet rays area radiated. The ultraviolet rays excite the fluorescent material applied to the inner wall of the glass tube and visible light such as white light is produced.

Some liquid crystal television receivers are configured to improve image clarity by slightly reducing the display brightness (brightness control) depending on ambient brightness and types of images to be displayed. For example, when the brightness control of the fluorescent lamp is performed during a startup of the liquid crystal television receiver or at a low temperature, neon or argon gas tends to be more excited than the mercury that has a low vapor pressure ratio. Under such a condition, infrared or near infrared rays produced by excitation of the neon gas or the argon gas are radiated from the fluorescent lamp in the backlight unit.

In this case, the infrared rays radiated from the backlight unit become noises and thus the television receiver may not be able to receive an infrared signal from the remote control. As a result, the television receiver may not be able to perform control that the user has requested through the remote control. Moreover, the noises may affect electronic devices around the television receiver. To reduce such problems, a temperature sensor may be installed in the liquid crystal television receiver to monitor the temperature of the fluorescent lamp and the brightness control is not performed when the temperature of the fluorescent lamp is low. With this configuration, however, the brightness control of the fluorescent lamp cannot be performed during the startup of the television receiver. Therefore, if the brightness of the display screen is too high or the brightness control request from the remote control is deactivated, a request from the user may not be accepted. To solve such a problem, temperature control performed immediately after a fluorescent lamp is turned on is disclosed in Patent Document 1.

Patent Document 1 discloses a device including a fluorescent lamp and a controller for turning on and off the fluorescent lamp. It further discloses a tube wall temperature increasing means for increasing a tube wall temperature of the fluorescent lamp for a certain period immediately after the fluorescent lamp is turned on. The tube wall temperature increasing means is controlled by the controller. With this configuration, the tube wall temperature of the fluorescent lamp is increased for the certain period and thus the energy having a noble gas spectrum can be quickly reduced. As a result, infrared rays reception interference is less likely to occur.

Patent Document 1: Japanese Published Patent Application No. H07-147196

### Problem to be Solved by the Invention

The device disclosed in Patent Document 1 may still have infrared rays reception interference until the temperature increase controlled by the tube wall temperature increasing means is completed after the fluorescent lamp is turned on. Furthermore, other factors including seasonal factors, such as a cold season, and geographic factors related to a location in which the television receiver is installed may affect the temperature decrease of the fluorescent lamp to a relatively low temperature, which increases chances of generation of infrared noises. Therefore, the above configuration does not provide an appropriate level of noise control.

### DISCLOSURE OF THE PRESENT INVENTION

The present invention was made in view of the foregoing circumstances. An object of the present invention is to provide a display device in which display brightness can be controlled while infrared radiation is controlled even when an ambient temperature is low. Another object of the present invention is to provide a television receiver including such a display device.

### Means for Solving the Problem

To solve the above problem, a display device of the present invention includes a display panel, a fluorescent lamp, a brightness controller and a temperature sensor. The display panel has a grayscale display function. The fluorescent lamp is configured to emit light toward the display panel. The brightness controller is configured to control the display brightness by adjusting grayscale of the display panel and the light emission of the fluorescent lamp. The temperature sensor is configured to measure a temperature of the display device. The brightness controller selects away of the brightness control from the display panel grayscale adjustment, the fluorescent lamp emission adjustment and a combination of both based on the temperature of the display device measured by the temperature sensor.

With this configuration, the brightness control by the display panel grayscale adjustment or by the fluorescent lamp emission adjustment, whichever is more effective, or by a combination of both can be selected based on the temperature of the display device measured by the temperature sensor. The temperature of the display device is subject to the temperature of the fluorescent lamp. The temperature is relatively low at a startup of the display device because it is immediately after the fluorescent lamp is tuned on. As the temperature of the fluorescent lamp in use increases, the temperature becomes relatively high. Therefore, the brightness control may be performed by the display panel grayscale adjustment at the startup of the display device when the temperature of the fluorescent lamp is low. In a stable state when the temperature of the fluorescent lamp is high, the brightness control may be performed by the fluorescent lamp emission adjustment. As a result, infrared radiation from the fluorescent lamp, which occurs when the temperature of the fluorescent lamp is low, can be controlled.

The fluorescent lamp included in the display device has a known configuration, that is, a grass tube with fluorescent material applied to inner walls thereof, and noble gas (e.g., neon and argon gases) and mercury are sealed in the glass tube. In the display device, the display brightness is controlled generally by adjusting (or reducing) the light emission of the fluorescent lamp to achieve preferable display brightness. If the brightness control is performed when the temperature of the fluorescent lamp is low, the neon or the argon gas is more dominantly excited than the mercury, which has a lower vapor pressure ratio. Under such a condition, infrared to near infrared rays are dominantly radiated from the fluorescent lamp due to the excitation of the neon or the argon gas.

The display device may include a remote control that a user uses for operation of the display device. A remote control that outputs infrared rays is widely used. When the user operates the remote control for desired operation, an infrared signal that contains a control command is sent from the remote control to the display device. In the display device, a specified procedure is executed according to the control command. If the brightness control is performed when the temperature of the fluorescent lamp is low such as at the startup of the display device, infrared rays are radiated from the fluorescent lamp. Such infrared rays could be noises that interfere with reception of the infrared signal from the remote control for the display device. As a result, the display device cannot perform the procedure specified by the remote control operation. Furthermore, the noises may affect electronic devices placed around the display device.

According to the configuration of the present invention, the brightness controller switches a way of the brightness control between the display panel grayscale adjustment and the fluorescent lamp emission adjustment based on the temperature of the display device measured by the temperature sensor. When the temperature of the display device, that is, the temperature of the fluorescent lamp is at a level at which infrared rays are dominantly radiated (i.e., at a low temperature), the display brightness is controlled by the display panel grayscale adjustment. When the temperature is at other levels (i.e., at a high temperature), the display brightness is controlled by the fluorescent lamp emission adjustment. As a result, when the temperature of the fluorescent lamp is low, that is, when the ambient temperature of the display device is low, the display brightness control is properly performed while the infrared radiation is controlled.

### BRIEF DESCRIPTION OF THE DRAWINGS

FIG. 1 is a front view illustrating a construction of a television receiver according to the first embodiment of the present invention;

FIG. 2 is an exploded perspective view illustrating a construction of the television receiver in FIG. 1;

FIG. 3 is an exploded perspective view illustrating a general construction of a liquid crystal display device included in the television receiver;

FIG. 4 is a cross-sectional view of the liquid crystal display device along a short-side direction thereof;

FIG. 5 is a cross-sectional view of the liquid crystal display device along a long-side direction thereof;

FIG. 6 is a block diagram illustrating a brightness control function of the television receiver;

FIG. 7 is a table providing an example of contents of a lockup table stored in a component on a controller board;

FIG. 8 is a flowchart illustrating a brightness control flow;

FIG. 9 is a chart illustrating variations in liquid crystal panel grayscale adjustment level and cold cathode tube emission adjustment level with respect to the measured temperature TL;

FIG. 10 is a table providing an example of contents of a lookup table stored in a component on the controller board of a liquid crystal display device according to the second embodiment of the present invention;

FIG. 11 is a flowchart illustrating a brightness control flow;

FIG. 12 is a block diagram illustrating architecture of brightness controller of the television receiver according to the third embodiment of the present invention;

FIG. 13 is a flowchart illustrating a brightness control flow;

FIG. 14 is a table providing an example of contents of a lookup table stored in a component on the controller board of a liquid crystal display device according to the fourth embodiment of the present invention;

FIG. 15 is a table providing an example of contents of another lookup table;

FIG. 16 is a flowchart illustrating a brightness control flow;

FIG. 17 is a chart illustrating variations in a liquid crystal panel grayscale adjustment level and the cold cathode tube emission adjustment level with respect to the measured temperature TL;

FIG. 18 is a table providing an example of contents of a lookup table stored in a component on the controller board of a liquid crystal display device according to the fifth embodiment of the present invention;

FIG. 19 is a flowchart illustrating a brightness control flow;

FIG. 20 is a table providing an example of contents of a lookup table stored in a component on the controller board of a liquid crystal display device according to the sixth embodiment of the present invention;

FIG. 21 is a chart illustrating variations in a liquid crystal panel grayscale adjustment level and the cold cathode tube emission adjustment level with respect to the measured temperature TL;

FIG. 22 is a table providing an example of contents of a lookup table stored in a component on the controller board of a liquid crystal display device according to the seventh embodiment of the present invention;

FIG. 23 is a chart illustrating variations in a liquid crystal panel grayscale adjustment level and the cold cathode tube emission adjustment level with respect to the measured temperature TL; and

FIG. 24 is a cross-sectional view of a modification of the liquid crystal display device with the temperature sensor arranged in a different location.

### BEST MODE FOR CARRYING OUT THE INVENTION

### First Embodiment

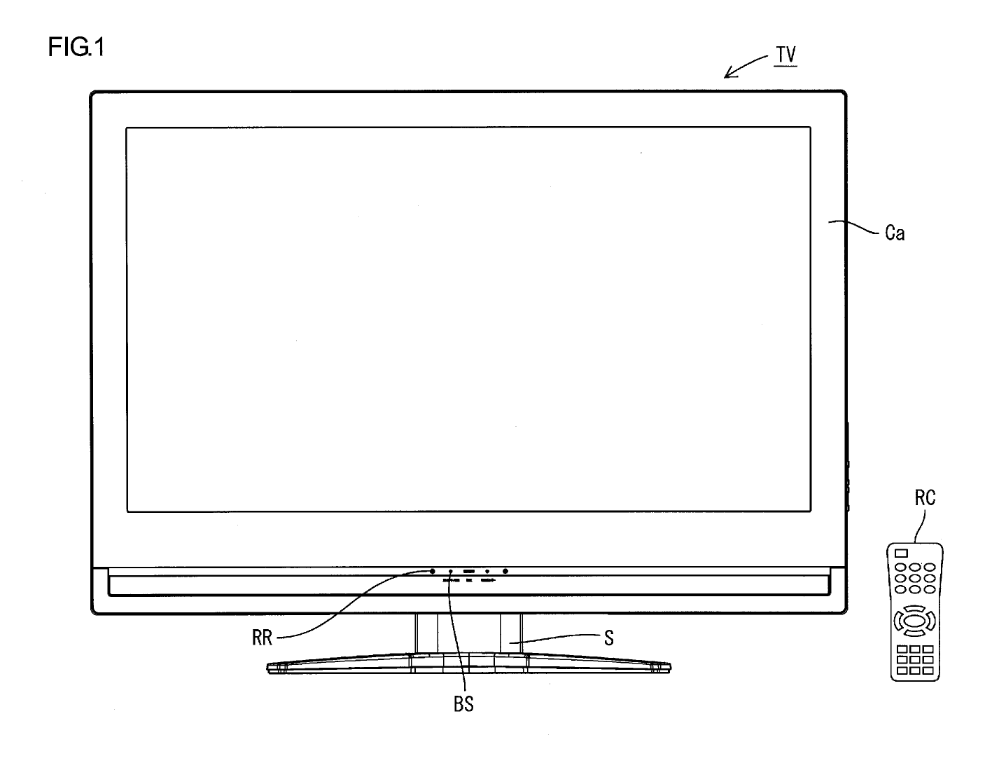

The first embodiment of the present invention will be explained with reference to FIGS. 1 to 8.

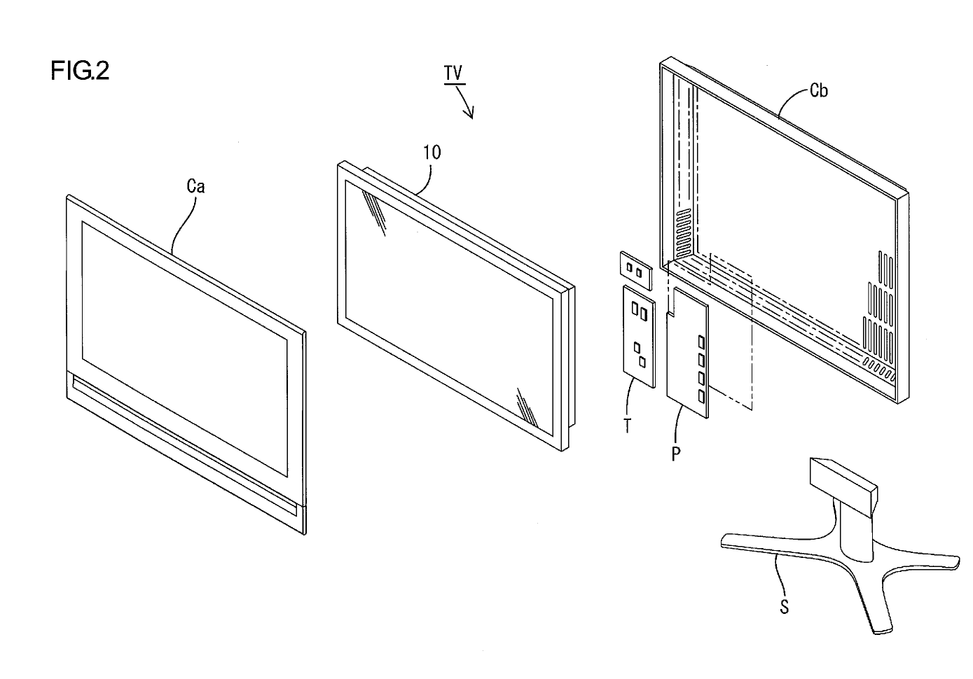

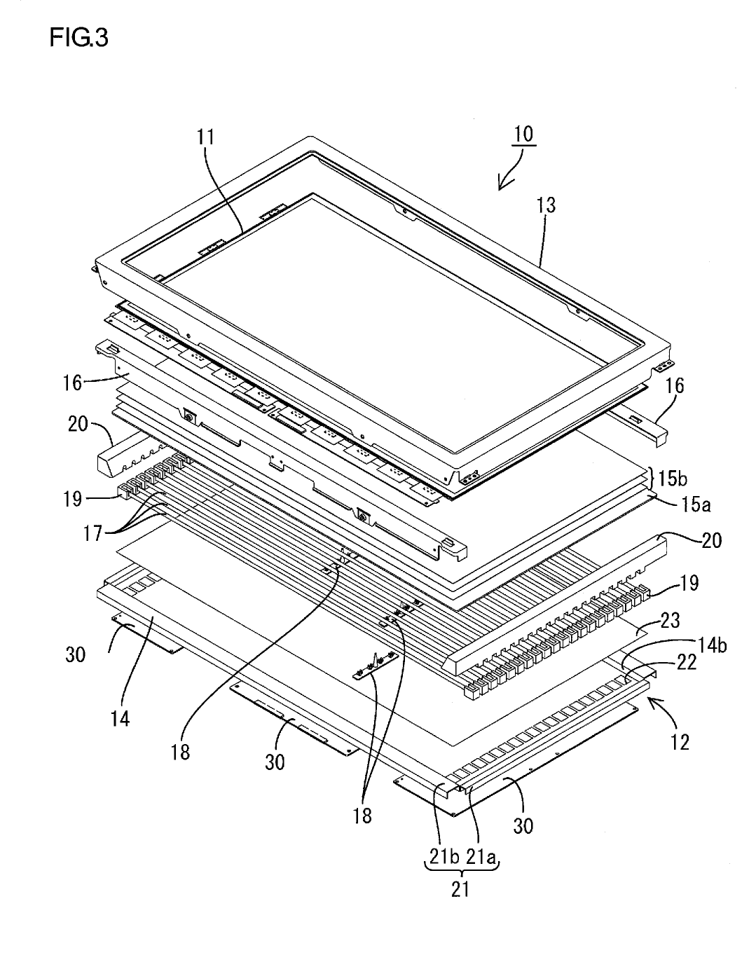

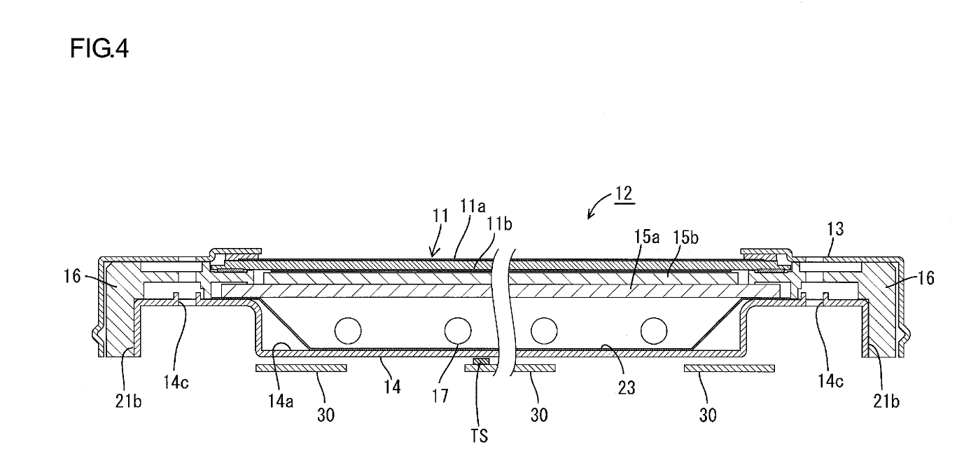

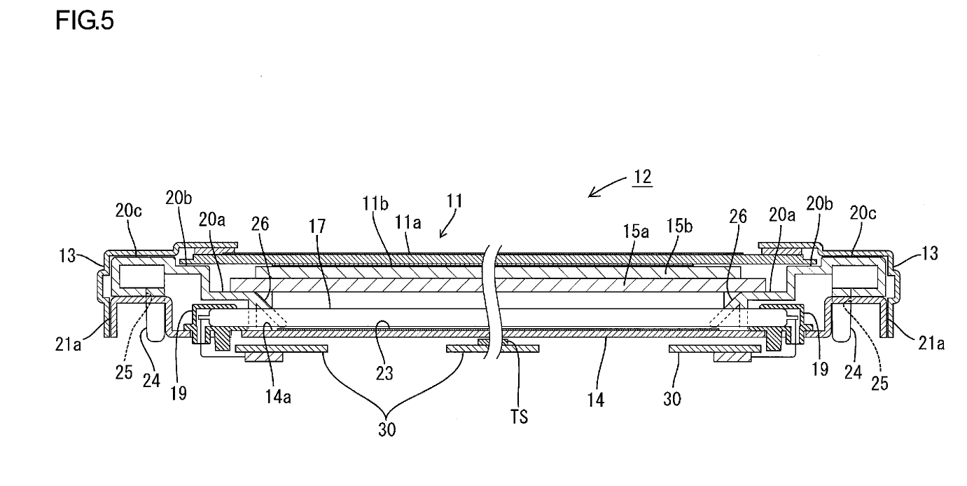

FIG. 1 is a front view illustrating a construction of a television receiver of this embodiment. FIG. 2 is an exploded perspective view illustrating a construction of the television receiver in FIG. 1. FIG. 3 is an exploded perspective view illustrating a general construction of a liquid crystal display device included in the television receiver in FIG. 1. FIG. 4 is a cross-sectional view of the liquid crystal display device in FIG. 3 along a short-side direction thereof. FIG. 5 is a cross-sectional view of the liquid crystal display device in FIG. 3 along a long-side direction thereof.

As illustrated in FIGS. 1 and 2, the television receiver TV of this embodiment includes a liquid crystal display device (display device) 10, front and rear cabinets CA, CB that house the liquid crystal display device 10 therebetween, a power source P, a tuner T, a stand S and a remote control RC. As illustrated in FIG. 1, the television receiver TV has a remote control receiver RR in a middle lower section of the front cabinet Ca for receiving infrared rays output from the remote control RC. The television receiver TV also has a brightness sensor BS for sensing ambient brightness in the middle lower section of the front cabinet Ca. The remote control RC outputs infrared signals to the remote control receiver RR for changing channel or volume setting for example. The liquid crystal display device 10 has a landscape rectangular overall shape and housed in the front and rear cabinets Ca, Cb in a vertical position. As illustrated in FIG. 3, the liquid crystal display panel 10 includes a liquid crystal panel (display panel) 11, which is a display panel, and a backlight unit 12, which is an external light source. They are held together with a frame shaped bezel 13.

Next, the liquid crystal panel 11 and the backlight unit 12 included in the liquid crystal display device 10 will be explained (see FIGS. 3 to 5).

The liquid crystal panel 11 is constructed such that a pair of glass substrates is bonded together with a predetermined gap therebetween and liquid crystals are sealed between the glass substrates. The liquid crystals are materials that change optical characteristics according to applications of electrical fields. On one of the glass substrates, switching components (e.g., TFTs) connected to source lines and gate lines that are perpendicular to each other, pixel electrodes connected to the switching components, and an alignment film are provided. On the other substrate, color filter having color sections such as R (red), G (green) and B (blue) color sections arranged in a predetermined pattern, counter electrodes, and an alignment film are provided. Polarizing plates 11a, 11b are attached to outer surfaces of the substrates (see FIGS. 4 and 5).

The liquid crystal panel 11 is configured such that the light transmission of each pixel electrode is varied by changing signal voltages of the source lines and changing the arrangement of liquid crystal molecules (i.e., grayscale adjustment). Namely, the brightness of the liquid crystal panel 11 can be adjusted by performing the grayscale adjustment to reduce total transmission of light from the backlight unit 12.

As illustrated in FIG. 3, the backlight unit 12 includes a chassis 14, a diffuser plate 15a, a plurality of optical sheets 15b and frames 16. The chassis 14 has a substantially box shape with an opening 14b on the light output side (on the liquid crystal panel 11 side). The diffuser plate 15a is arranged so as to cover the opening 14b of the chassis 14. The optical sheets 15b are arranged between the diffuser plate 15a and the liquid crystal panel 11. The frames 16 are arranged along long sides of the chassis 14 so as to hold long-side edges of the diffuser plate 15a by sandwiching them between the chassis 14 and the frames 16. Cold cathode tubes 17 (fluorescent lamps), lamp clips 18, relay connectors 19 and holders 20 are housed in the chassis 14. The lamp clips 18 are used for mounting the cold cathode tubes 17 to the chassis 14. The relay connectors 19 make electrical connections at the ends of the cold cathode tubes 17. The holders 20 collectively cover the ends of the cold cathode tubes and the relay connectors 19. A light output side of the backlight unit 12 is a side closer to the diffuser plate 15a than the cold cathode tubes 17.

The chassis 14 is made of metal. As illustrated in FIGS. 4 and 5, the chassis 14 is formed in a substantially shallow box shape by metal plate processing. It has a rectangular bottom plate 14a and folded outer rim portions 21 (short-side folded outer rim portions 21a and long-side folded outer rim portions 21b), each of which extends upright from the corresponding side of the bottom plate 14a and has a substantially U shape. The bottom plate 14a has a plurality of through holes, that is, mounting holes 22, along the long-side edges thereof. The relay connectors 19 are mounted in the mounting holes 22. As illustrated in FIG. 4, fixing holes 14c are provided in the top surface of the chassis 14 along the long-side outer rims 21b to bind the bezel 13, the frames 16 and the chassis 14 together with screws and the like.

A light reflecting sheet 23 is disposed on an inner surface of the bottom plate 14a of the chassis 14 (on a side that faces the cold cathode tubes 17). The light reflecting sheet 23 is a synthetic resin sheet having a surface in white color that provides high light reflectivity. It is placed so as to cover almost entire inner surface of the bottom plate 14a of the chassis 14. As illustrated in FIG. 4, long-side edges of the light reflecting sheet 23 are lifted so as to cover the long-side outer rims 21b of the chassis 14 and sandwiched between the chassis 14 and the diffuser plate 15a. With this light reflecting sheet 23, light emitted from the cold cathode tubes 17 is reflected toward the diffuser plate 15a. On the outer surface of the bottom plate 14a of the chassis 14 (on a side opposite from the cold cathode tubes 17), a controller board set 30 is provided for supplying power to the cold cathode tubes 17.

On the opening 14b side of the chassis 14, the diffuser plate 15a and the optical sheets 15b are provided. The diffuser plate 15a includes a synthetic resin plate containing scattered light diffusing particles. It diffuses linear light emitted from the cold cathode tubes 17. The short-side edges of the diffuser plate 15a are placed on the first surface 20a of the holder 20 as described above, and does not receive a vertical force. As illustrated in FIG. 4, the long-side edges of the diffuser plate 15a are sandwiched between the chassis 14 (more precisely the reflecting sheet 23) and the frame 16 and fixed.

The optical sheets 15b provided on the diffuser plate 15a includes a diffuser sheet, a lens sheet and a reflecting type polarizing plate layered in this order from the diffuser plate 15a side. Light emitted from the cold cathode tubes 17 passes through the diffuser plate 15a and enters the optical sheets 15b. The optical sheets 15b convert the light to planar light. The liquid crystal display panel 11 is disposed on the top surface of the top layer of the optical sheet 15b. The optical sheet 15b are held between the diffuser plate 15a and the liquid crystal panel 11.

Each cold cathode tube 17 has an elongated tubular shape. A plurality of the cold cathode tubes 17 are installed in the chassis 14 such that they are arranged parallel to each other with the long-side direction thereof (the axial direction) aligned along the long-side direction of the chassis 14 (see FIG. 3). Each cold cathode tube 17 is held with the lamp clips 18 (not shown in FIGS. 4 and 5) slightly away from the bottom plate 14a (or the reflecting sheet 23). Each end of each cold cathode tube 17 has a terminal (not shown) for receiving drive power and is fitted in the corresponding relay connector 19. The holders 20 are mounted so as to cover the relay connectors 19. The cold cathode tubes 17 are driven by pulse width modulation (PWM) signals. The amount of light can be reduced (i.e., the brightness can be adjusted) by changing a time ratio between turnon time and turnoff time (i.e., the PWM duty ratio).

The holders 20 that cover the ends of the cold cathode tubes 17 are made of white synthetic resin. As illustrated in FIG. 3, each holder 20 has an elongated substantially box shape and extends along the short-side direction of the chassis 14. As illustrated in FIG. 5, each holder 20 has steps on the front side such that the diffuser plate 15a and the liquid crystal panel 11 are held at different levels. A part of the holder 20 is placed on top of a part of the corresponding short-side outer rim 21a of the chassis 14 and forms a side wall of the backlight unit 12 together with the short-side outer rim 21a. An insertion pin 24 projects from a surface of the holder 20 that faces the outer rim 21a of the chassis 14. The holder 20 is mounted to the chassis 14 by inserting the insertion pin 24 into the insertion hole 25 provided in the top surface of the short-side outer rim 21a of the chassis 14.

The steps of the holder 20 include three surfaces parallel to the bottom plate 14a of the chassis 14. The short edge of the diffuser plate 15a is placed on the first surface 20a located at the lowest level. A sloped cover 26 extends from the first surface 20a toward the bottom plate 14a of the chassis 14. A short edge of the liquid crystal panel 11 is placed on the second surface 20b. The third surface 20c located at the highest level is provided such that it overlaps the short-side outer rim 21a of the chassis 14 and comes in contact with the bezel 13.

On outer surface of the bottom plate 14a of the chassis 14 (on a side opposite from a side on which the cold cathode tubes 17 are arranged), the controller board set 30 including a brightness controller, which will be explained later, is mounted (see FIGS. 4 and 5). The controller board set 30 includes a circuit for supplying driving power to the cold cathode tubes 17 and controlling lighting conditions (e.g. the light emission). It also includes a circuit for controlling the grayscale of the liquid crystal panel 11. With the controller board set 30, the television receiver TV has an automatic tone adjustment function for automatically adjusting the brightness of display images according to ambient brightness sensed by the brightness sensor BS.

The controller board set 30 further includes a temperature sensor TS for measuring the ambient temperature around the cold cathode tubes 17 (see FIGS. 4 and 5). The temperature sensor TS is a thermistor, for example. It constantly measures a temperature and inputs the measured temperature TL as a temperature of the cold cathode tubes 17 to the brightness controller 40 included in the controller board set 30.

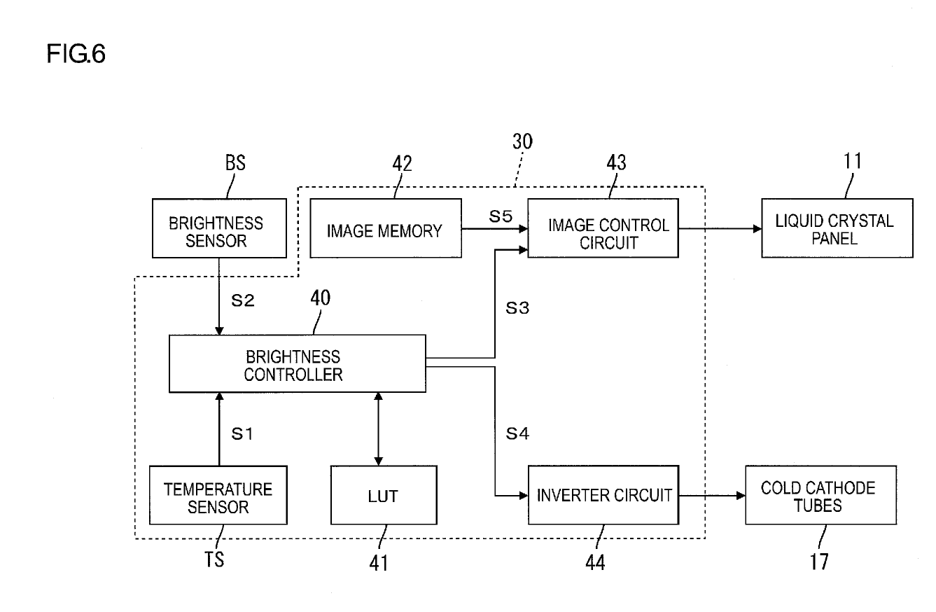

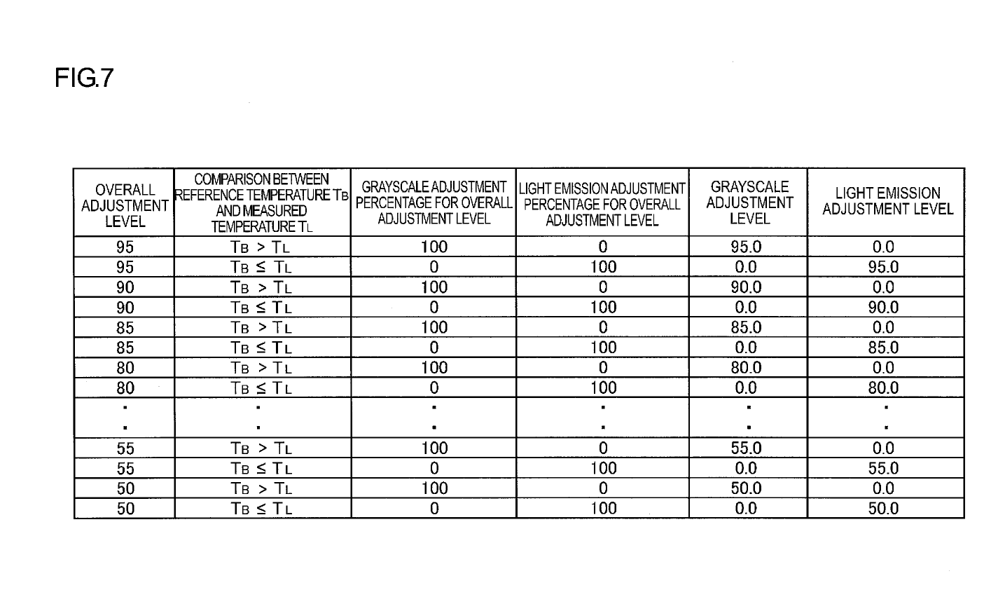

Next, an example of the brightness control by adjusting the light emission of the cold cathode tubes 17 and by adjusting a grayscale of the liquid crystal panel 11 will be explained with reference to FIGS. 6 and 7.

FIG. 6 is a block diagram illustrating the brightness control function of the television receiver. FIG. 7 is a table providing an example of contents of a lockup table stored in the component on a controller board. In FIG. 6, the brightness controller 40, the temperature sensor TS, the lockup table (LUT) 41, an image memory 42, an image control circuit 43 and an inverter circuit 44 are included in the controller board set 30 that is mounted to the rear surface of the chassis 14.

As described above, the temperature sensor TS is a thermistor, for example, for constantly measuring an ambient temperature and sending a temperature signal S1 that contains data on the measured temperature (temperature of the cold cathode tubes) TL to the brightness controller 40.

As described the above, the brightness sensor BS is provided in the front cabinet Ca of the television receiver TV. It constantly senses the ambient brightness and sends a brightness signal S2 to the brightness controller 40.

The brightness controller 40 determines whether the display brightness needs to be adjusted based on the brightness signal S2 from the brightness sensor BS. If the adjustment is needed, the brightness controller 40 determines the adjustment level (overall adjustment level). The overall adjustment level shows actual display brightness when the maximum brightness is 100. The overall adjustment level is determined based on the liquid crystal panel 11 grayscale adjustment and the cold cathode tube 17 emission adjustment.

Then, the brightness controller 40 refers to the LUT 41 illustrated in FIG. 7 as an example and selects either the liquid crystal panel 11 grayscale adjustment or the cold cathode tube 17 emission adjustment.

The LUT 41 in FIG. 7 contains overall adjustment level information in the first column and conditional expression information in the second column. The conditional expression information shows relationships between the measured temperature TL and a predetermined reference temperature TB (TB=15° C. in this embodiment). The display brightness control is switched between the liquid crystal panel 11 grayscale adjustment and the cold cathode tube 17 emission adjustment based on the relationships. The cold cathode tubes 17 of this embodiment dominantly emit infrared rays when the temperature is under 14° C. The reference temperature is set above that temperature, that is, TB=15° C.

If the measured temperature TL is lower than 15° C., a percentage for the overall adjustment level by the liquid crystal panel 11 grayscale adjustment (grayscale adjustment percentage) is 100 while a percentage of the brightness control by the cold cathode tube 17 emission adjustment (light emission adjustment percentage) is 0. Namely, the table indicates that the display brightness control is performed by adjusting the grayscale of the liquid crystal panel 11.

The LUT 41 further contains information on adjustment levels for the grayscale adjustment of the liquid crystal panel 11 (grayscale adjustment level) and adjustment levels for the cold cathode tube 17 emission adjustment (light emission adjustment level) in the fifth column and the sixth column, respectively. The grayscale adjustment level and the light emission adjustment level are derived from the overall adjustment level and percentages of the grayscale adjustment and the light emission adjustment. A sum of the grayscale adjustment level and the light emission adjustment level for each measured temperature TL is equal to the overall adjustment level for that measured temperature TL. If the overall adjustment level is 85, one of two rows having 85 in the first column and an expression showing that the measured temperature TL is lower than the reference temperature TB in the second column of the LUT 41 is referred. From the LUT 41, the level of the liquid crystal panel 11 adjustment (grayscale adjustment level) is set to 85 and the level of the cold cathode tube 17 emission adjustment (light emission adjustment level) is set to 0.

If the measured temperature TL is 15° C. or higher, the grayscale adjustment percentage is 0 and the light emission adjustment percentage is 100. Namely, the display brightness control is performed by adjusting the light emission of the cold cathode tubes 17. In this case, the light emission adjustment level is 85 and the grayscale adjustment level is 0 for the overall adjustment level of 85.

The brightness controller 40 generates a grayscale adjustment signal S3 and an INV output adjustment signal S4 based on readouts from the LUT 41. Namely, the brightness controller 40 generates the grayscale adjustment signal S3 based on the grayscale adjustment level in the LUT 41 and the INV output adjustment signal S4 based on the light emission adjustment level. Then, it sends the grayscale adjustment signal S3 and the INV output adjustment signal S4 to the image control circuit 43 and the inverter circuit 44, respectively, and performs the display brightness control.

The image control circuit 43 determines the grayscale (light transmission) of the liquid crystal panel 11 and performs image display control based on an image signal S5 from the image memory 42 and the grayscale adjustment signal S3 from the brightness controller 40.

The inverter circuit 44 determines a duty ratio of PWM signals generated by the PWM signal generator circuit (not shown) based on the light emission adjustment level specified by the INV output adjustment signal S4. Then, it adjusts the light emission of the cold cathode tubes 17.

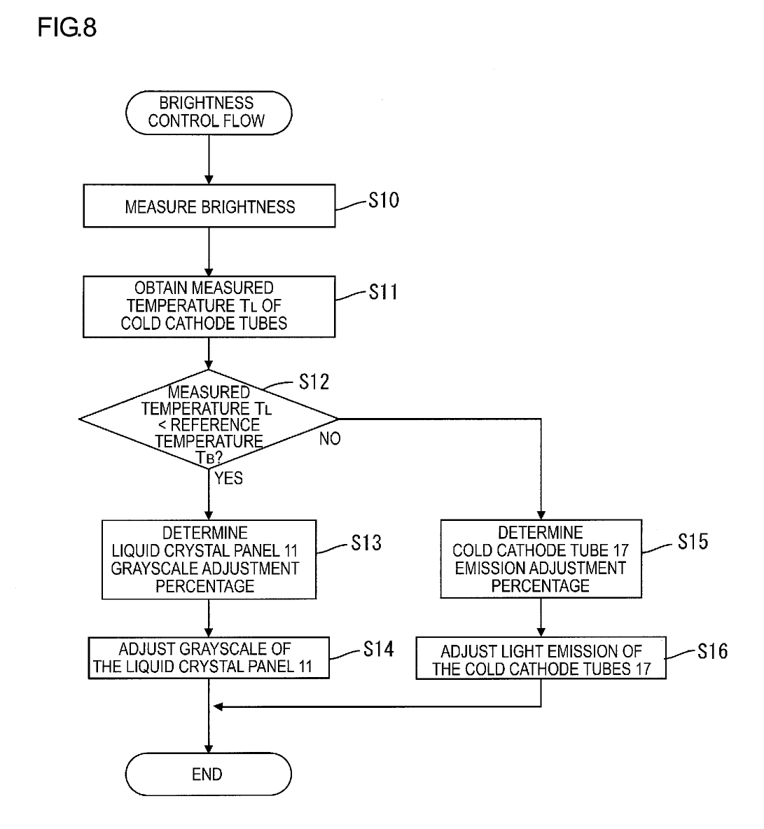

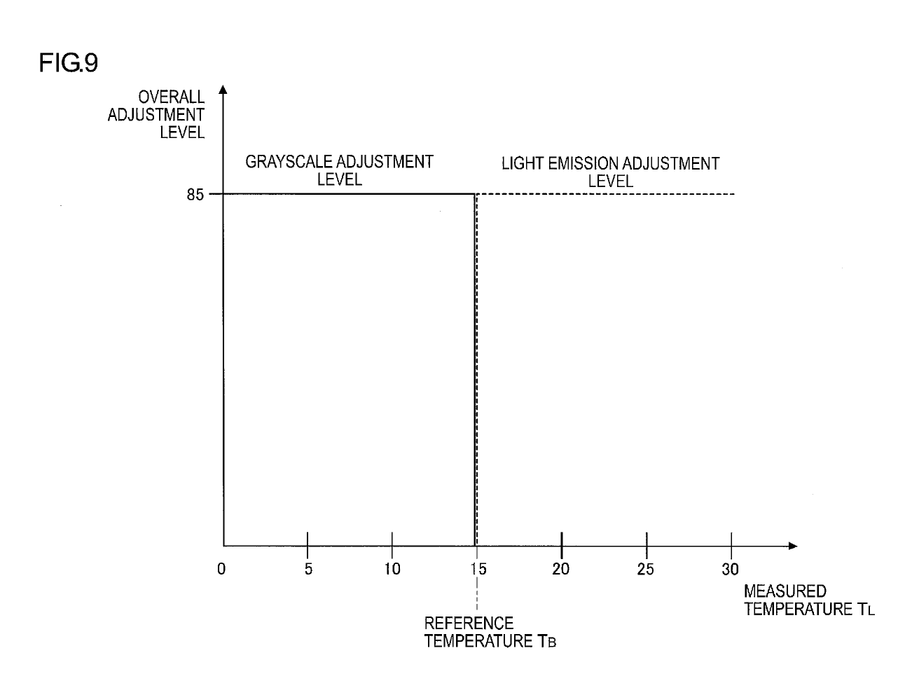

Next, the brightness control procedure of this embodiment will be explained. FIG. 8 is a flowchart of the brightness control. FIG. 9 is a chart illustrating variations in liquid crystal panel grayscale adjustment level and cold cathode tube light emission adjustment level with respect to the measured temperature TL.

The ambient brightness (brightness) is measured by the brightness sensor BS (step S10) and the brightness signal S2 is sent to the brightness controller 40. The ambient temperature around the cold cathode tubes 17 is measured by the temperature sensor TS (step S11) and the temperature signal S1 indicating the measured temperature TL (temperature of the cold cathode tubes 17) is sent to the brightness controller 40.

The brightness controller 40 determines the adjustment level (overall adjustment level) of the display brightness. The brightness controller 40 then refers to the LUT 41 and compares the measured temperature TL input from the temperature sensor TS with the predetermined reference temperature TB (step S12). If the measured temperature TL is lower than the reference temperature TB (YES in step S12), the liquid crystal panel 11 grayscale adjustment percentage is determined (step S13) based on the LUT 14. As a result, the liquid crystal panel 11 grayscale adjustment is selected for the brightness control and the gray scale adjustment signal S3 that specifies the grayscale adjustment level is sent to the image control circuit 43. The INV output adjustment signal S4 indicating that the light emission adjustment is not performed for the brightness control (i.e., the light transmission adjustment level is 0) is sent to the inverter circuit 44.

The image control circuit 43 receives the grayscale adjustment signal S3 and adjusts the grayscale of the liquid crystal panel 11 based on the signal S3 (step S14). Namely, it performs the brightness control by the liquid crystal panel 11. The inverter circuit 44 receives the INV output adjustment signal S4 and sets the light emission of the cold cathode tubes 17 to the maximum so that the cold cathode tubes 17 are not involved in the display brightness control.

If the measured temperature TL is equal to or higher than the reference temperature TB (NO in step S12), the cold cathode tube 17 emission adjustment percentage is determined (step S15). As a result, the cold cathode tube 17 emission adjustment is selected for the display brightness control. The INV output adjustment signal S4 that specifies the light emission adjustment level is sent to the inverter circuit 44. The grayscale adjustment signal S3 indicating that the grayscale adjustment of the liquid crystal panel 11 is not performed for the brightness control is sent to the image control circuit 43.

The inverter circuit 44 receives the INV output adjustment signal S4 and performs the light emission adjustment of the cold cathode tubes 17 based on the signal S4 (step S16). Namely, it performs the display brightness control by the cold cathode tubes 17. The image control circuit 43 receives the grayscale adjustment signal S3 and sets the light transmission of the liquid crystal panel 11 to the maximum so that the liquid crystal panel 11 is not involved in the display brightness control.

Through such display brightness control steps, the display brightness is controlled by varying the grayscale adjustment level and the light emission adjustment level according to the measured temperature TL as illustrated in FIG. 9. If the measured temperature TL is lower than 15°, which is the reference temperature TB, the grayscale adjustment level is set to 85 and the light emission adjustment level is set to 0. Namely, the display brightness control is performed by adjusting only the grayscale of the liquid crystal panel 11. If the measured temperature TL is equal to or higher than 15°, the light emission adjustment level is set to 85 and the grayscale adjustment level is set to 0. Namely, the display brightness control is performed by adjusting only the light emission of the cold cathode tubes 17.

As described the above, the liquid crystal display device 10 of this embodiment automatically adjusts the brightness of the display screen according to the ambient brightness. It selects a way of the brightness control from the grayscale adjustment of the liquid crystal display panel 11 and the light emission adjustment of the cold cathode tubes 17 based on the temperature TL of the liquid crystal display panel 10 (i.e., the ambient temperature around the cold cathode tubes 17 in this embodiment). The temperature TL is measured by the temperature sensor TS.

With such a configuration, either one of the liquid crystal display panel 11 grayscale adjustment and the cold cathode tube emission adjustment, whichever is appropriate for the brightness control, is selected based on the measured temperature TL. For example, when the temperature of the cold cathode tubes 17 is low, for instance during the startup of the liquid crystal display device 10, the brightness control is performed by the grayscale adjustment of the liquid crystal display panel 11. When the temperature becomes high and the cold cathode tubes 17 are in the stable condition, the brightness control is performed by the light emission adjustment of the cold cathode tubes 17. Therefore, the infrared rays radiated when the temperature of the cold cathode tubes is low can be reduced.

In the cold cathode tubes 17 included in the liquid crystal display device 10, neon gas or argon gas is more excited than mercury that has a smaller vapor pressure ratio when the brightness control is performed at the low temperature. In such a condition, the infrared rays dominantly are radiated from the cold cathode tubes 17 due to the excitation of the neon gas or the argon gas.

The liquid crystal display device 10 includes the remote control RC used for operation of the display device by the user. The remote control RC sends an infrared signal containing a control command to the liquid crystal display device 10 when the user manipulates the remote control for desired operation such as channel switching. The liquid crystal display device 10 executes a predetermined process based on the control command. If the brightness control is performed when the temperature of the cold cathode tubes 17 is low such as during the startup of the liquid crystal display device 10, the infrared rays radiating from the cold cathode tube 17 acts as noise for the crystal display device 10 while receiving the infrared signal from the remote control RC. As a result, the liquid crystal display device 10 cannot properly perform the operation that the user has requested through the remote control RC. Furthermore, the infrared rays may affect electronic devices around the liquid crystal display device 10.

According to the configuration of this embodiment, the brightness controller 40 switches the brightness control between the grayscale adjustment of the liquid crystal panel 11 and the light emission adjustment of the cold cathode tubes 17 based on the temperature (measure temperature) TL of the cold cathode tubes 17 measured by the temperature sensor TS. With this configuration, when the temperature TL of the cold cathode tubes 17 is in a range that the infrared rays dominantly are radiates (15° C. in this embodiment), the brightness control is performed by the grayscale adjustment of the liquid crystal panel 11. If the temperature is in the other range (15° C. or higher in this embodiment), the brightness control is performed by the light emission adjustment of the cold cathode tubes 17. Therefore, the display brightness is properly adjusted while the infrared radiation is controlled even when the temperature at which the liquid crystal display device 10 is used is low.

The brightness controller 40 of this embodiment executes the brightness control by the grayscale adjustment of the liquid crystal panel 11 when the temperature TL of the cold cathode tubes 17 is lower than the predetermined reference temperature TB (=15° C.). It executes the brightness control by the light emission adjustment of the cold cathode tubes 17 when the temperature TL of the cold cathode tubes 17 is equal to the predetermined reference temperature TB (=15° C.) or higher.

By setting the reference temperature TB higher than the temperature at which the infrared rays are dominantly radiated from the cold cathode tubes 17 (lower than 14° C.) so that the brightness controller 40 selects the brightness control by the grayscale adjustment before the temperature TL of the cold cathode tubes 17 reaches the reference temperature TB, the display brightness can be adjusted while the infrared emission is controlled even when the temperature at which the liquid crystal display device 10 is used is low.

The temperature sensor TS of this embodiment is arranged in the controller board set 30 and measures the ambient temperature around the cold cathode tubes 17.

The ambient temperature around cold cathode tubes 17 is measured as the temperature of the liquid crystal display device 10. Moreover, the temperature sensor TS is arranged around the cold cathode tubes 17, that is, the temperature sensor TS is not necessary to be a thermocouple sensor, which is subject to breakage. Therefore, stable temperature measurement is available. In this embodiment, the ambient temperature around the cold cathode tubes 17 is used as the temperature of the liquid crystal display device 10. However, an actual temperature of the liquid crystal display device 10 may be defined by an actual temperature of the cold cathode tubes 17 calculated or assumed from the ambient temperature.

### Second Embodiment

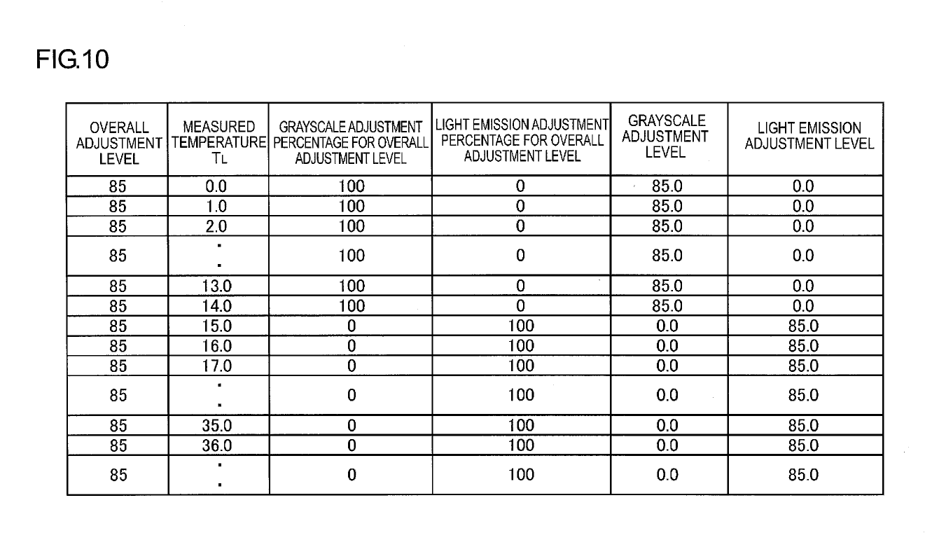

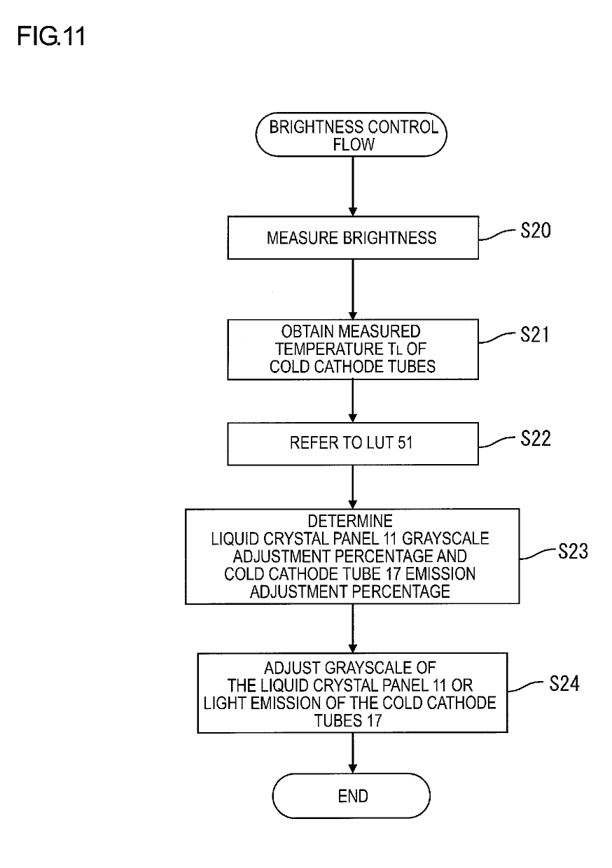

Next, the second embodiment of the present invention will be explained with reference to FIGS. 10 and 11. The second embodiment uses different LUTs but other configurations are the same as the first embodiment. The parts same as the first embodiment will be indicated by the same symbols and will not be explained.

FIG. 10 illustrates an example of contents of a lookup table stored in a component on a controller board of a liquid crystal display device of this embodiment.

A plurality of LUTs 51 are provided for different overall adjustment levels. For example, the LUT 51 in FIG. 10 is referred when the overall adjustment level is 85 (shown in the first column). The second column contains a measured temperature list. According to the LUT 51 of this embodiment, percentages of the grayscale adjustment and the light emission adjustment are 100 and 0, respectively, when the measured temperature TL is lower than 15° C. When the measured temperature TL is equal to or higher than 15° C., the percentages of the grayscale adjustment and the light emission adjustment are 0 and 100, respectively. Namely, the LUT 51 contains the percentages of the grayscale adjustment and the light emission adjustment for each temperature.

Next, the brightness control procedure of this embodiment will be explained. FIG. 11 is a flowchart illustrating a brightness control flow.

Ambient brightness is measured by the brightness sensor BS (step S20) and a brightness signal S2 is sent to the brightness controller 40. An ambient temperature is measured by the temperature sensor TS (step S21) and a temperature signal S1 containing information on the measured temperature (temperature of the cold cathode tubes 17) TL is sent to the brightness controller 40.

The brightness controller 40 determines a display brightness level (an overall brightness level) and refers to one of the LUTs 51 appropriate for the overall brightness level (step S22). The brightness controller 40 then determines percentages of the grayscale adjustment of the liquid crystal panel 11 and the light emission adjustment of the cold cathode tubes 17 based on the LUT 51 and the measured temperature TL input from the temperature sensor TS (step S23). Then, it sends a grayscale signal S3 that specifies the grayscale adjustment level defined based on the overall adjustment level and the grayscale adjustment percentage to the image control circuit 43. It also sends an INV output adjustment signal S4 that specifies the light emission adjustment level defined based on the overall adjustment level and the light emission adjustment percentage to the inverter circuit 44.

The image control circuit 43 and the inverter circuit 44 performs the grayscale adjustment of the liquid crystal panel 11 and the light emission adjustment of the cold cathode tubes 17 based on the grayscale adjustment signal S3 and the INV output adjustment signal S4, respectively (step S24).

As described the above, in the liquid crystal display device 10 of this embodiment, the brightness controller 40 selects one of the liquid crystal panel 11 grayscale adjustment and the cold cathode tube 17 emission adjustment based on the temperature TL of the liquid crystal display device 10 (the ambient temperature around the cold cathode tubes 17 in this embodiment) measured by the temperature sensor TS.

With this configuration, the brightness control by the liquid crystal panel 11 grayscale adjustment or by the cold cathode tube 17 emission adjustment, whichever is effective, can be selected based on the measured temperature TL. Especially, the brightness control can be switched between the liquid crystal panel 11 grayscale adjustment and the cold cathode tube 17 emission adjustment based on the measured temperature TL by referring to the row of the LUT 51 corresponding the measured temperature TL. By preparing more precise LUT 51, more precise switching is available if necessary.

### Third Embodiment

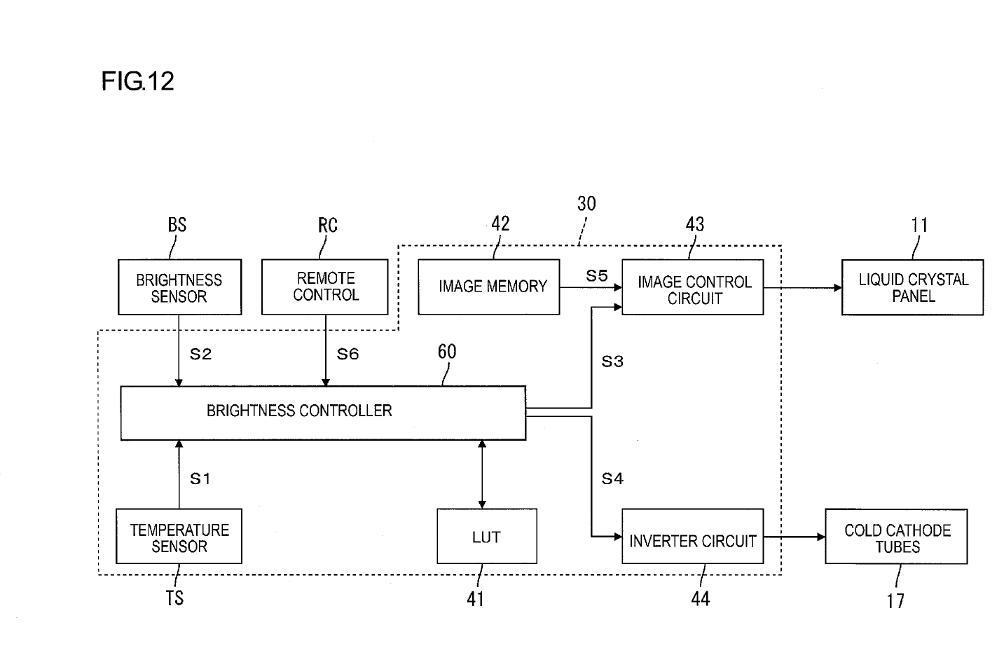

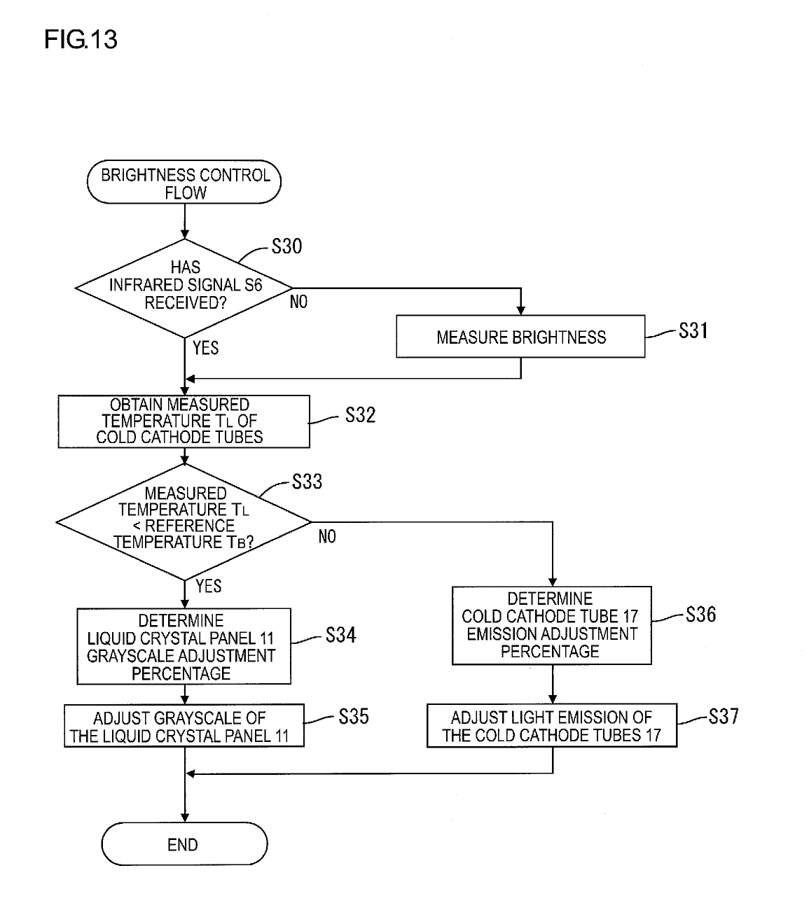

Next, the third embodiment of the present invention will be explained with reference to FIGS. 12 and 13. In the third embodiment, the brightness can be adjusted through a remote control. Other configurations are the same as the first embodiment. The parts same as the first embodiment will be indicated by the same symbols and will not be explained.

FIG. 12 is a block diagram illustrating a configuration of brightness control function of a television receiver of this embodiment.

The television receiver TV of this embodiment includes an automatic brightness adjustment function for automatically adjusting the brightness of display images according to the ambient brightness measured by the brightness sensor BS. The user can manually adjust the brightness of the display images through the remote control RC.

The remote control RC sends an infrared signal S6 containing a control command to the remote control receiver RR (see FIG. 1) when the user operates it for desired operation. The user can switch channels, change volumes and manually adjust the display brightness.

As illustrated in FIG. 12, the brightness controller 60 determines whether the brightness control is necessary based on the brightness signal S2 input from the brightness sensor BS. If the brightness control is necessary, it determines the brightness adjustment level (overall adjustment level). When the infrared signal S6 regarding the brightness control is sent from the remote control RC, the infrared signal S6 is dominant over the brightness signal S2. The brightness control is performed based on the overall adjustment level specified by the infrared signal S6. Namely, the brightness controller 60 performs the brightness control based on the adjustment level set by the user regardless of the adjustment level determined based on brightness signal S2 when the infrared signal S6 regarding the brightness control is sent from the remote control RC. The brightness controller 60 refers to the LUT 41 based on the adjustment level specified by the brightness signal S2 or the infrared signal S6 and the temperature signal S1 sent from the temperature sensor TS (see FIG. 7). Then, it selects the liquid crystal panel 11 grayscale adjustment or the cold cathode tube 17 emission adjustment for the brightness control.

The brightness controller 60 generates the grayscale adjustment signal S3 and the INV output adjustment signal S4 based on the readouts from the LUT 41. It generates the grayscale adjustment signal S3 based on the grayscale adjustment level in the LUT 41 and sends it to the image control circuit 43. It generates the INV output adjustment signal S4 based on the light emission adjustment level and sends it to the inverter circuit 44. It performs the brightness control for the display brightness.

The image control circuit 43 determines the grayscale (or light transmission) of the liquid crystal panel 11 based on the grayscale adjustment signal S3 sent from the brightness controller 40 and performs the image display control.

The inverter circuit 44 determines the duty ratio of PWM signals generated by the PWM signal generator (not shown) based on the light emission adjustment level specified by the INV output adjustment signal S4 and adjusts the light emission of the cold cathode tubes 17.

Next, the brightness control procedure of this embodiment is performed will be explained. FIG. 13 is a flowchart illustrating a brightness control flow.

When the user inputs a brightness control command through the remote control RC, the infrared signal S6 is sent to the brightness controller 60 (YES in step S30). If the user does not input the brightness control command through the remote control RC (No in step S30), the ambient brightness is measured by the brightness sensor BS (step S31) and the brightness signal S2 is sent to the brightness controller 60. The ambient temperature around the cold cathode tubes 17 is measured by the temperature sensor TS (step S32) and the temperature signal S1 indicating the measured temperature (temperature of the cold cathode tubes 17) TL is sent to the brightness controller 60.

If no infrared signal S6 is input, the brightness controller 60 compares the measured temperature TL sent from the temperature sensor TS with the predefined reference temperature TB based on the brightness signal S2 (step S33). If the measured temperature TL is lower than the reference temperature TB (YES in step S33), the liquid crystal panel 11 grayscale adjustment percentage is defined based on the LUT 41 (step S34). As a result, the liquid crystal panel 11 grayscale adjustment is selected for the display brightness control. The grayscale adjustment signal S3 that specifies the grayscale adjustment level is sent to the image control circuit 43. Moreover, the INV output adjustment signal S4 indicating that the light emission is not performed for the brightness control (i.e., the light emission adjustment level is 0) is sent to the inverter circuit 44.

The image control circuit 43 performs the display brightness control by adjusting the grayscale of the liquid crystal panel 11 based on the input grayscale adjustment signal S3 (step S35). The inverter circuit 44 adjusts the light emission of the cold cathode tubes 17 to the maximum level control based on the input INV output adjustment signal S4 so that they will not be involved in the brightness.

If the measured temperature TL is equal to the reference temperature TB or higher (NO in step S33), the cold cathode tube 17 emission adjustment percentage is determined (step S36). As a result the cold cathode tube 17 emission adjustment is selected for the display brightness control and the INV output adjustment signal S4 that specifies the light emission adjustment level is sent to the inverter circuit 44. Moreover, the grayscale adjustment signal S3 indicating that the liquid crystal panel 11 grayscale adjustment is not performed for the brightness adjustment is sent to the image control circuit 43.

The inverter circuit 44 adjusts the light emission of the cold cathode tubes 17 based on the input INV output adjustment signal S4 (step S37), that is, performs the display brightness control by the adjustment of the cold cathode tubes 17. The image control circuit 43 adjusts the light transmission of the liquid crystal panel 11 to the maximum level based on the input grayscale adjustment signal S3 so that the liquid crystal panel 11 will not be involved in the display brightness control.

As described the above, the television receiver of this embodiment adjusts the brightness of the display screen based on the brightness sensor BS or the operation of the user on the remote control RC. The brightness controller 40 selects either the liquid crystal panel 11 grayscale adjustment or the cold cathode tube 17 emission adjustment for the brightness control based on a relationship between the temperature TL of the liquid crystal display device 10 (the ambient temperature around the cold cathode tubes 17 in this embodiment) measured by the temperature sensor TS and the reference temperature TB.

With this configuration, the liquid crystal panel 11 grayscale adjustment or the cold cathode tube 17 emission adjustment, whichever is effective for the brightness control, can be selected. Especially when the user adjusts the brightness control using the remote control RC, the brightness control is switched between the liquid crystal panel 11 grayscale adjustment and the cold cathode tube 17 emission adjustment based on the relationship between the measured temperature TL and the predefined reference temperature TB. This can reduce the radiation of the infrared rays from the cold cathode tubes 17 at a low temperature and provide high user satisfaction.

### Fourth Embodiment

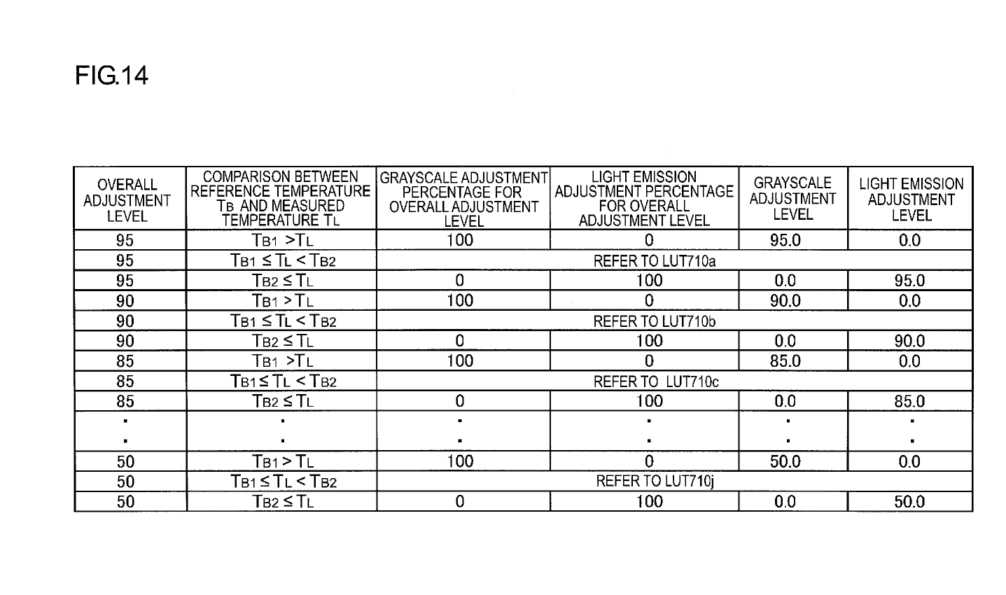

Next, the fourth embodiment of the present invention will be explained with reference to FIGS. 14 to 17. The fourth embodiment has different brightness control configurations but other configurations are the same as the first embodiment. The parts same as the first embodiment are indicated by the same symbols and will not be explained.

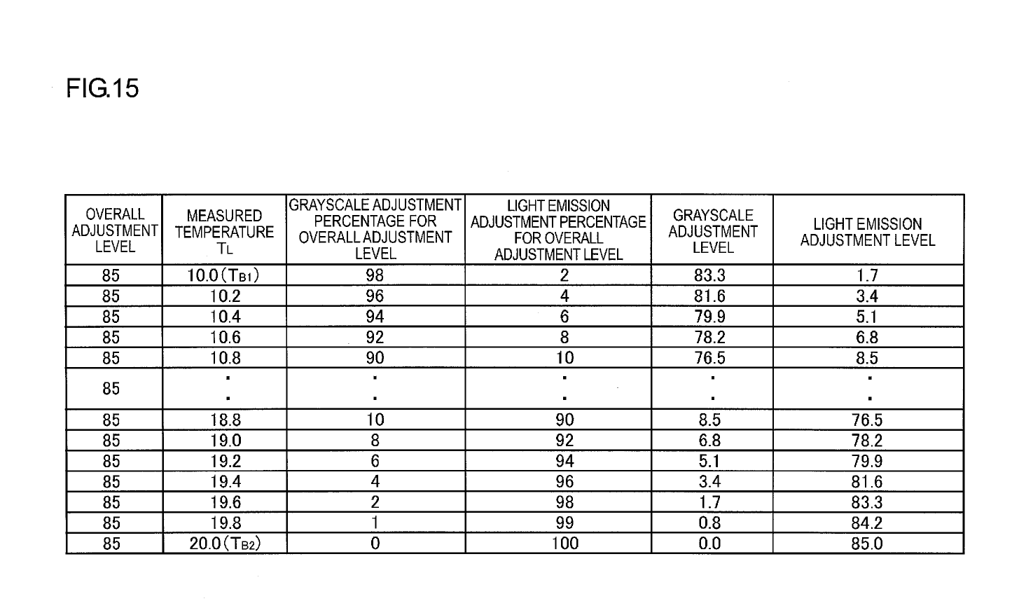

FIG. 14 is a table providing an example of contents of a lookup table stored in a component on the controller board of a liquid crystal display device of contents of a lookup table. FIG. 15 is a table providing an example of contents of another lookup table.

As illustrated in FIG. 14, the second column of an LUT 71 contains expressions that express relationships between the measured temperatures TL, the first predetermined reference temperature TB1 (TB1=10° C. in this embodiment) and the second predetermined reference temperature TB2 (TB2=20° C. in this embodiment) for different overall adjustment levels. The liquid crystal panel 11 grayscale adjustment and/or the cold cathode tube 17 emission adjustment is selected for the brightness control based on the relationship between the measured temperature TL, the first reference temperature TB1 and the second reference temperature TB2.

For each overall adjustment level, when the measured temperature TL is lower than the first reference temperature TB1, a percentage of the liquid crystal panel 11 grayscale adjustment (grayscale adjustment percentage) of the brightness control for the overall adjustment level is 100 and a percentage of the cold cathode tube 17 emission adjustment (light emission adjustment percentage) is 0. Namely, the display brightness control is performed by the liquid crystal panel 11 grayscale adjustment. When the measured temperature TL is equal to the second reference temperature TB2 or higher, the light emission adjustment percentage is 100 and the grayscale adjustment percentage is 0. Namely, the display brightness control is performed by the cold cathode tube 17 emission adjustment. When the measured temperature TL is in a range from the first reference temperature TB1 to the second reference temperature TB2, the LUTs 710a to 710j are referred for respective overall brightness levels.

For example, the LUT 710c in FIG. 10 is referred when the overall adjustment level is 85 (in the first column). The second column contains a list of the measured temperatures TL between 10° C. and 20° C. (the first reference temperature TB1 to the second reference temperature TB2). In the LUT 710c, the grayscale adjustment percentage decreases by 2 and the light emission adjustment percentage increases by 2 as the measured temperature TL increases by 0.2° C. from 10° C. to 20° C. When the measured temperature TL is in a range from 10° C. to 20° C., the grayscale adjustment percentage gradually decreases and the light emission adjustment percentage gradually increases. The sum of the grayscale adjustment percentage and the light emission adjustment percentage is 100.

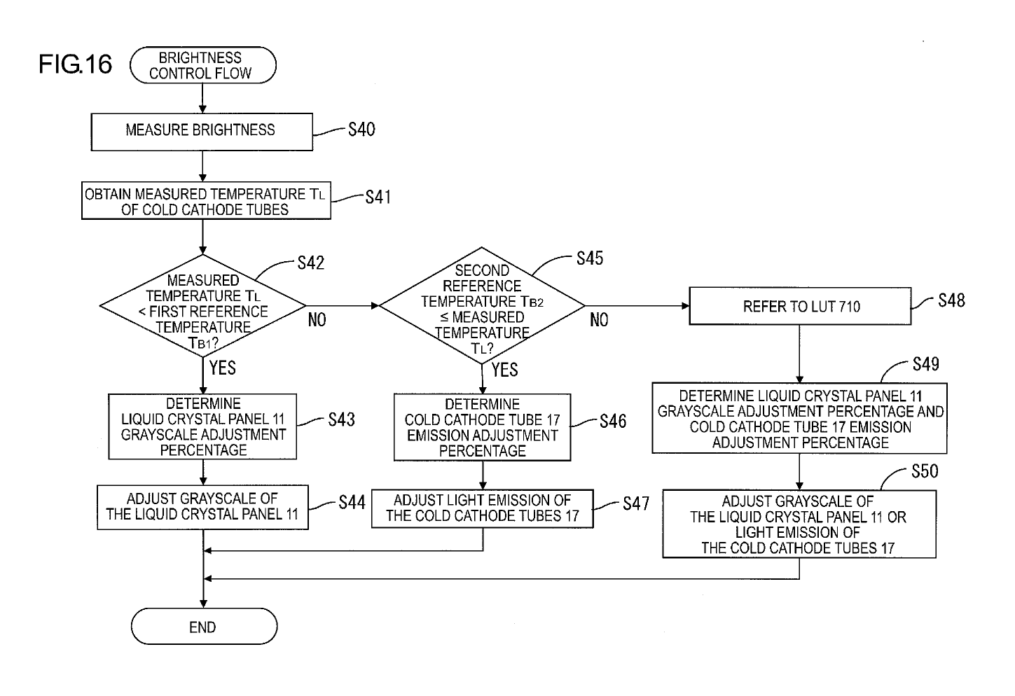

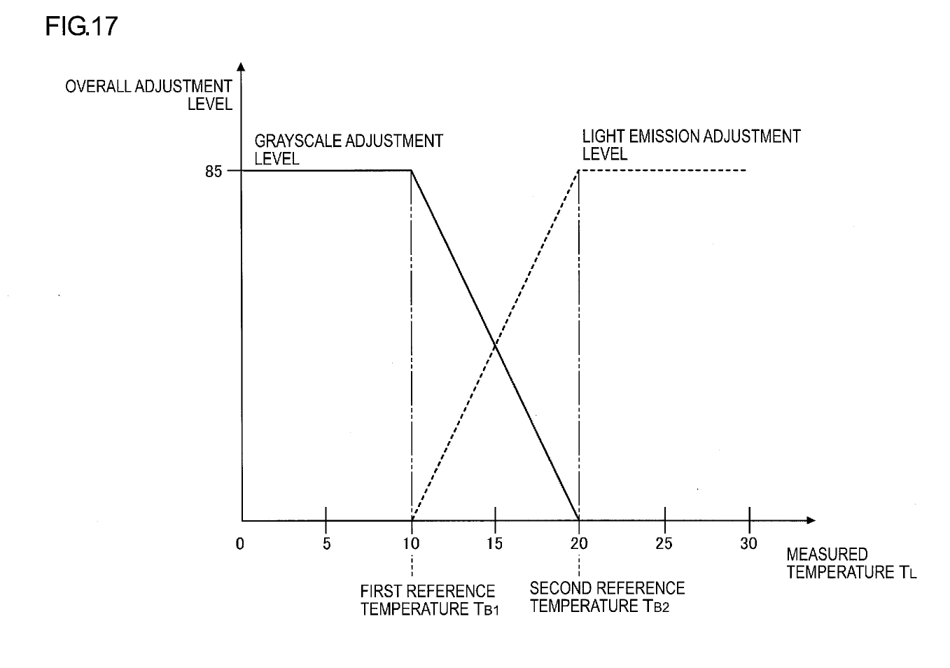

Next, the brightness control procedure of this embodiment will be explained. FIG. 16 is a flowchart illustrating a brightness control flow. FIG. 17 is a chart illustrating variations in a liquid crystal panel grayscale adjustment level and the cold cathode tube emission adjustment level with respect to the measured temperature TL.

The ambient brightness is measured by the brightness sensor BS (step S40) and the brightness signal is sent to the brightness controller 40. The ambient temperature is measured by the temperature sensor TS (step S41) and the temperature signal S1 indicating the measured temperature (temperature of the cold cathode tubes 17) TL is sent to the brightness controller 40.

The brightness controller 40 determines the adjustment level (overall adjustment level) of the display brightness based on the brightness signal S2. Then, it refers to the LUT 71 and compares the measured temperature TL included in the signal sent from the temperature sensor TS to the predetermined first reference temperature TB1 (step S42). If the measured temperature TL is lower than the first reference temperature TB1 (YES in step S42), the liquid crystal panel 11 grayscale adjustment percentage is determined according to the LUT 71 (step S43). Namely, the grayscale adjustment of the liquid crystal panel 11 is selected for the display brightness control and the grayscale adjustment signal S3 that specifies the grayscale adjustment level is sent to the image control circuit 43. The INV output adjustment signal S4 indicating that the light emission adjustment is not performed for the brightness control (i.e., the light emission adjustment level is 0) is sent to the inverter circuit 44.

The image control circuit 43 adjusts the grayscale of the liquid crystal panel 11 based on the input grayscale adjustment signal S3, that is, performs the display brightness control by the adjustment of the liquid crystal panel 11. The inverter circuit 44 adjusts the light emission of the cold cathode tubes 17 to the maximum level based on the input INV output adjustment signal S4 so that the cold cathode tubes 17 are not involved in the display brightness control.

If the measured temperature TL is equal to the first reference temperature TB1 or higher (NO in step S42), the brightness controller 40 refers to the LUT 71 and compares the measured temperature TL to the predetermined second reference temperature TB2 (step S45). If the measured temperature TL is equal to the second reference temperature TB2 or higher (YES in step S45), the cold cathode tube 17 emission adjustment percentage is determined according to the LUT 71 (step S46). Namely, the cold cathode tube 17 emission adjustment is selected for the display brightness control and the INV output adjustment signal S4 that specifies the light emission adjustment level is sent to the inverter circuit 44. The grayscale adjustment signal S3 indicating that the grayscale adjustment of the liquid crystal panel 11 is not performed for the brightness control is sent to the image control circuit 43.

The inverter circuit 44 adjusts the light emission of the cold cathode tubes 17 based on the input INV output adjustment signal S4 (step S 47), that is, performs the display brightness control by the adjustment of the cold cathode tubes 17. The image control circuit 43 adjusts the light transmission of the liquid crystal panel 11 to the maximum level based on the input grayscale adjustment signal S3 so that the liquid crystal panel 11 is not involved in the display brightness control.

If the measured temperature TL is lower than the second reference temperature (NO in step S45), the brightness controller 40 refers to the LUT 710 (any one of the LUTs 710a to 710j) according to the LUT 71 (step S48). Then, it determines the liquid crystal panel 11 grayscale adjustment percentage and the cold cathode tube 17 emission adjustment percentage based on the measured temperature TL (step S49). It sends the grayscale adjustment signal S3 that specifies the grayscale adjustment percentage to the image control circuit 43 and the INV output adjustment signal S4 that specifies the light emission adjustment percentage to the inverter circuit 44.

The image control circuit 43 and the inverter circuit 44 adjust the grayscale of the liquid crystal panel 11 based on the input grayscale adjustment signal S3 and the light emission of the cold cathode tubes 17 based on the input INV output adjustment signal S4, respectively (step S50).

By such adjustments, the grayscale adjustment percentage and the light emission adjustment percentage are changed according to the measured temperature TL as illustrated in FIG. 17 and the brightness is controlled. If the measured temperature TL is lower than 10° C., that is, the first reference temperature TB1, the grayscale adjustment percentage is set to 85 and the light emission adjustment percentage is set to 0. Namely, the display brightness control is only performed by the grayscale adjustment of the liquid crystal display panel 11. If the measured temperature TL is equal to or higher than 20° C., that is, the second reference temperature TB2, the light emission adjustment percentage is set to 85 and the grayscale adjustment percentage is set to 0. Namely, the display brightness control is only performed by the cold cathode tube 17 emission adjustment. If the measured temperature TL is in the range from the first reference temperature TB1 to the second reference temperature TB2, the grayscale adjustment percentage is set so as to gradually decrease from 85 to 0 as the measured temperature TL increases from the first reference temperature TB1 (10° C.) to the second reference temperature TB2. In the same manner, the light emission adjustment percentage is set so as to gradually increase from 0 to 85. In that temperature range, the brightness control is performed by a combination of the liquid crystal panel 11 grayscale adjustment and the cold cathode tube 17 emission adjustment. If the measured temperature TL is relatively close to the first reference temperature TB1, the cold cathode tube 17 emission adjustment percentage of the brightness control for the overall adjustment level is smaller than the liquid crystal panel 11 grayscale adjustment percentage. If the measured temperature TL is relatively close to the second reference temperature TB2, the liquid crystal panel 11 grayscale adjustment percentage for the overall adjustment level is smaller than the cold cathode tube 17 emission adjustment percentage.

In the liquid crystal display device 10 of this embodiment, the first reference temperature TB1 and the second reference temperature TB2, which is higher than the first reference temperature TB1, are set. If the measured temperature TL is higher than the first reference temperature TB1, the brightness control is performed by the liquid crystal panel 11 grayscale adjustment. If the measured temperature TL is in the range from the first reference temperature TB1 to the second reference temperature TB2, the brightness control is performed by a combination of the liquid crystal panel 11 grayscale adjustment and the cold cathode tube 17 emission adjustment. If the measured temperature TL is lower than the second reference temperature TB2, the brightness control is performed by the cold cathode tube 17 emission adjustment.

In this configuration, the first reference temperature TB1 and the second reference temperature TB2 are set within a range in which infrared rays are dominantly radiated from the cold cathode tubes 17 (lower than 14° C. in this embodiment) on either side of the highest temperature in the temperature range in which the infrared rays are radiated from the cold cathode tubes 17. The first reference temperature TB1 is lower than that temperature (i.e., 10° C. in this embodiment) and the second reference temperature TB2 is higher than that temperature (i.e., 20° C. in this embodiment). As a result, the display brightness can be controlled while the infrared radiation from the cold cathode tubes 17 is controlled.

When the measured temperature TL is in the range from the first reference temperature TB1 to the second reference temperature TB2, the overall adjustment level percentage of the liquid crystal display device 10 is determined based on the brightness control by a combination of the liquid crystal panel 11 grayscale adjustment and the cold cathode tube 17 emission adjustment. If the measured temperature TL is relatively close to the first reference temperature TB1, the cold cathode tube 17 emission adjustment percentage for the overall adjustment level is smaller than the liquid crystal panel 11 grayscale adjustment percentage.

In this case, if the measured temperature TL is closer to the first reference temperature TB1 than the second reference temperature TB2, the cold cathode tube 17 emission adjustment percentage is small, that is, the liquid crystal panel 11 grayscale adjustment is more dominant. By setting the first reference temperature TB lower than the temperature at the highest end of the temperature range in which the infrared rays are radiated from the cold cathode tubes 17, the display brightness can be adjusted while the infrared radiation is relatively low.

In this embodiment, when the measured temperature TL is relatively closer to the second reference temperature TB2 than the first reference temperature TB1, the liquid crystal panel 11 grayscale adjustment percentage for the overall adjustment level is smaller than the cold cathode tube 17 emission adjustment percentage.

In this case, when the measured temperature TL is closer to the second reference temperature TB2 than the first reference temperature TB1, the liquid crystal panel 11 grayscale adjustment percentage is small and the cold cathode tube 17 emission adjustment becomes dominant. Therefore, the power consumption can be reduced in comparison to the brightness adjustment performed by the liquid crystal panel 11 grayscale adjustment without the cold cathode tube 17 emission adjustment. This contributes to energy saving.

Especially in this embodiment, the cold cathode tube 17 emission adjustment percentage for the overall adjustment level gradually increases as the temperature increases from the first reference temperature TB1 to the second reference temperature TB2.

The infrared radiation from the cold cathode tubes 17 gradually decreases as the temperature of the cold cathode tubes 17 increases. With the configuration in which the cold cathode tube 17 emission adjustment percentage gradually increases as the temperature increases from the first reference temperature TB1 to the second reference temperature TB2, the infrared radiation is effectively controlled.

### Fifth Embodiment

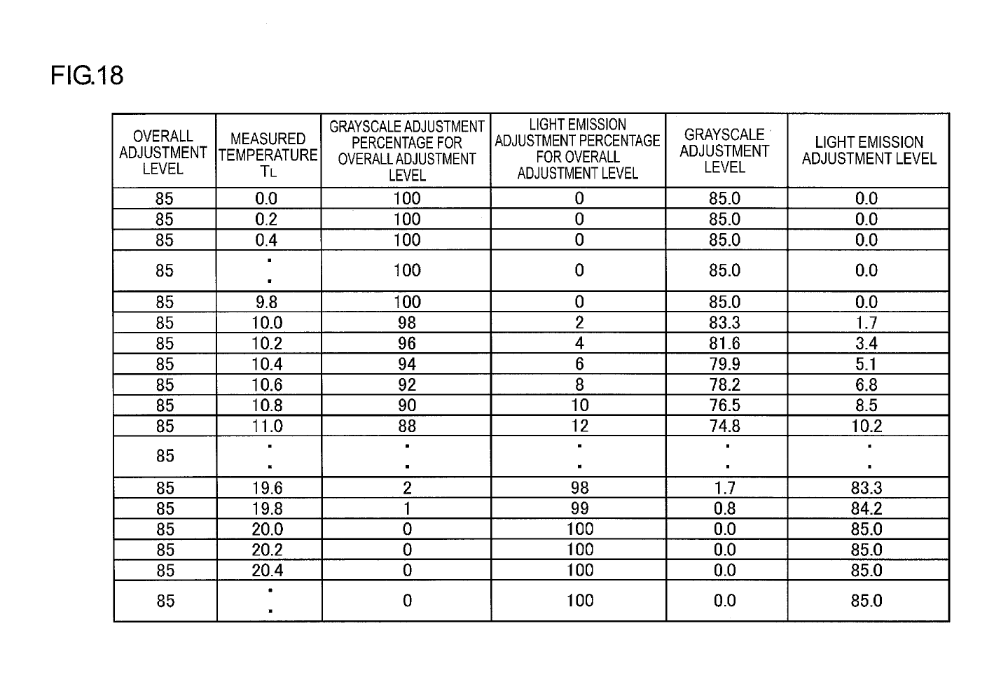

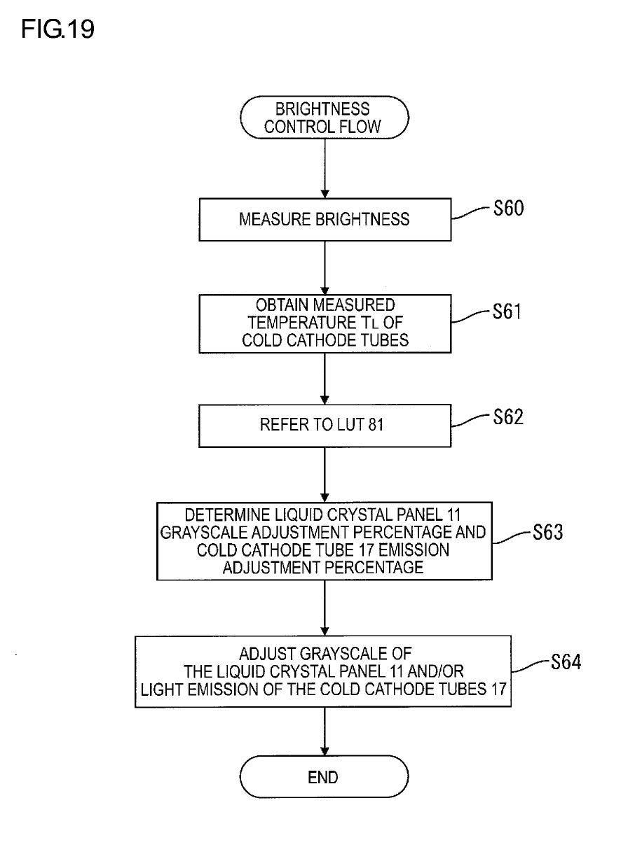

Next, the fifth embodiment of the present invention will be explained with reference to FIGS. 18 and 19. In the fifth embodiment, the LUT has a different configuration but other parts are the same as the first embodiment. The parts same as the first embodiment are indicated by the same symbols and will not be explained.

FIG. 18 is a table for providing an overview of contents of a lookup table included in the control board of the liquid crystal display device of this embodiment.

LUTs 81 are provided for different overall adjustment levels. For example, the LUT 81 in FIG. 18 is referred when the overall adjustment level is 85 (in the first column). The second column contains a list of temperatures corresponding to the measured temperatures TL. According to the LUT 81 of this embodiment, when the measured temperature TL is lower than 10° C., the grayscale adjustment percentage and the light emission adjustment percentage for the overall adjustment level are 100 and 0, respectively. When the measured temperature TL is equal to 20° C. or higher, the light emission adjustment percentage and the grayscale adjustment percentage for the overall adjustment level are 100 and 0, respectively. When the measured temperature is in the range from 10° C. to 20° C., the grayscale adjustment percentage gradually decreases from 100 to 0 and the light emission adjustment percentage gradually increases from 0 to 100 as the measured temperature TL increases from 10° C. to 20° C.

Next, the brightness control procedure of this embodiment will be explained. FIG. 19 is a chart illustrating a brightness control flow.

The brightness sensor BS senses ambient brightness (brightness) (step S60) and a brightness signal S2 is sent to the brightness controller 40. The temperature sensor TS measures an ambient temperature (step S61) and a temperature signal S1 regarding the measured temperature (temperature of the cold cathode tubes 17) TL is sent to the brightness controller 40.

The brightness controller 40 determines an adjustment level of the display brightness control (overall adjustment level) based on the brightness signals S2 and refers to an appropriate one of the LUTs 81 for the overall adjustment level (step S62). Then, it determines the liquid crystal panel 11 grayscale adjustment percentage and the cold cathode tube 17 emission adjustment percentage referring to the LUT 81 and based on the measured temperature TL input from the temperature sensor TS (step S63). Specifically, if the measured temperature TL is lower than 10° C. (the first reference temperature TB1 in this embodiment), only the liquid crystal panel 11 grayscale adjustment is selected. If the measured temperature TL is in a range from 10° C. to 20° C. (the second reference temperature TB2 in this embodiment), both liquid crystal panel 11 grayscale and cold cathode tube 17 emission adjustment are selected (i.e., a combination of both). If the measured temperature TL is equal to 20° C. or higher, only the cold cathode tube 17 emission adjustment is selected. The brightness controller 40 sends a grayscale adjustment signal S3 that specifies the grayscale adjustment percentage to the image control circuit 43 and an INV output adjustment signal S4 that specifies the light emission adjustment percentage to the inverter circuit 44.

The image control circuit 43 and the inverter circuit 44 adjust the grayscale of the liquid crystal panel 11 based on the grayscale adjustment signal S3 and the light emission of the cold cathode tubes 17 based on the INV output adjustment signals S4, respectively (step S64).

With this configuration, the brightness can be effectively controlled by the liquid crystal panel 11 grayscale adjustment or the cold cathode tube 17 emission adjustment, whichever is effective, or the combination of both. The brightness controller 40 only needs to refer to one of the LUTs 81 to select either one of the grayscale adjustment of the liquid crystal panel 11 and the cold cathode tube 17 emission adjustment or the combination of both. Namely, it can precisely control the brightness with a simple configuration.

### Sixth Embodiment

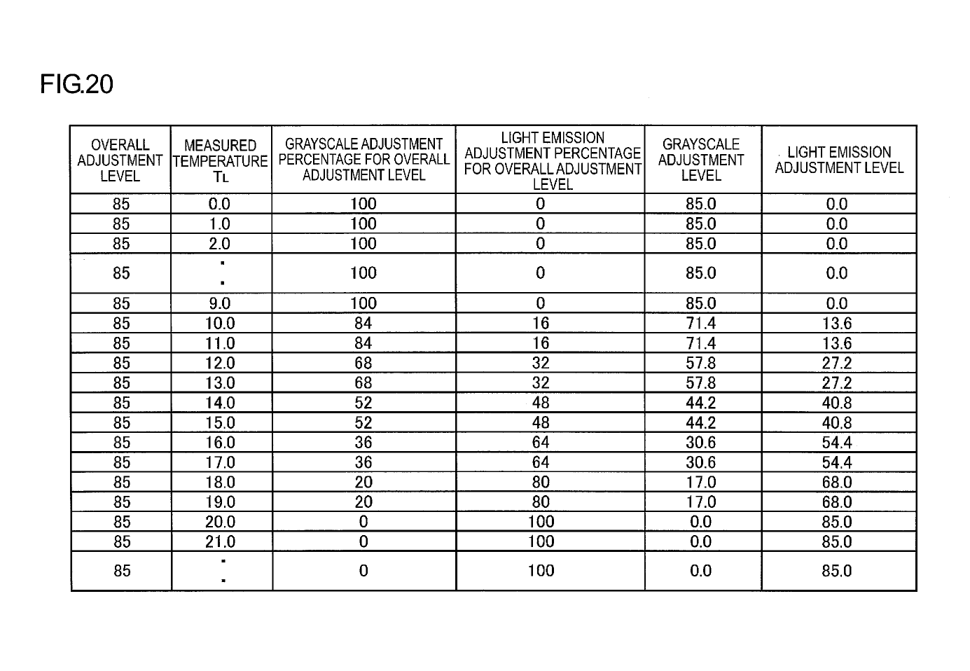

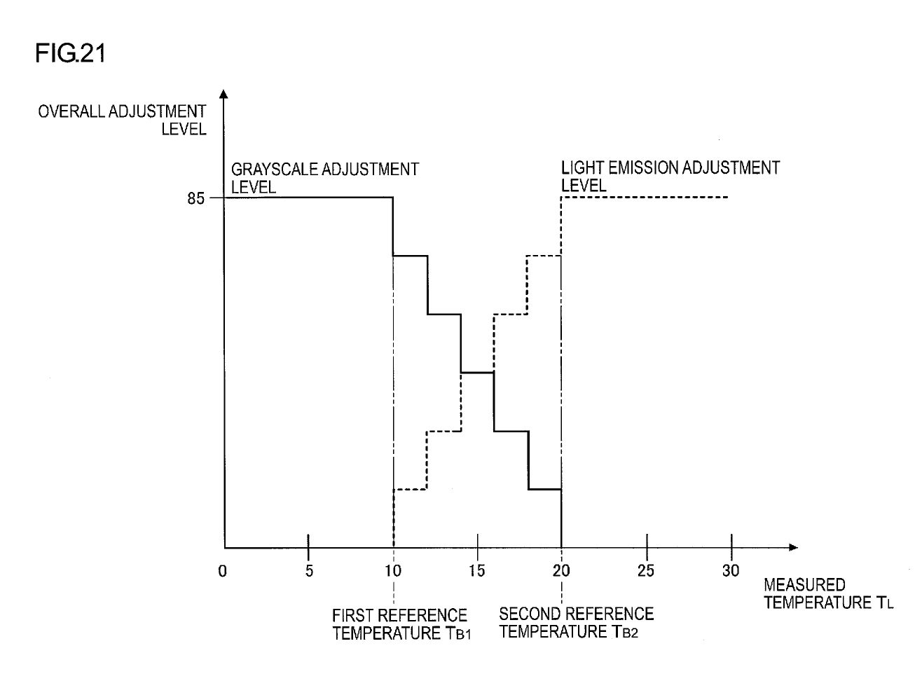

Next, the sixth embodiment of the present invention will be explained with reference to FIGS. 20 and 21. In the sixth embodiment, the LUTs have different configurations but other parts are the same as the first embodiment. The parts same as the first embodiment are indicated by the same symbols and will not be explained.

FIG. 20 is a table for providing an overview of contents of a lookup table included in the control board of the liquid crystal display device of this embodiment. FIG. 21 is a chart illustrating variations in the grayscale adjustment level and the light emission adjustment level with respect to the measured temperature TL.

LUTs 91 are provided for different overall adjustment levels. For example, the LUT 91 in FIG. 20 is referred when the overall adjustment level is 85 (in the first column). The second column contains a list of temperatures corresponding to the measured temperatures TL. According to the LUT 91 of this embodiment, when the measured temperature TL is lower than 10° C., the grayscale adjustment percentage and the light emission percentage in the overall adjustment level are 100 and 0, respectively. When the measured temperature TL is equal to 10° C. or higher, the light emission adjustment percentage and the grayscale adjustment percentage in the overall adjustment level are 100 and 0, respectively. When the measured temperature is in the range from 10° C. to 20° C., the grayscale adjustment percentage decreases stepwise from 100 to 0 and the light emission adjustment percentage increases stepwise from 0 to 100 as the measured temperature TL increases from 10° C. to 20° C. More specifically, the grayscale adjustment percentage decreases about 16 and the light emission adjustment percentage increases about 16 as the measured temperature TL increases by 2° C.

The brightness control is performed by referring to the LUT 91. As illustrated in FIG. 21, the grayscale adjustment percentage and the light emission adjustment percentage are changed according to the measured temperature TL and the brightness is adjusted. If the measured temperature TL is lower than 10° C., which is the first reference temperature TB1, the grayscale adjustment percentage is 85 and the light emission adjustment percentage is 0. Namely, the display brightness adjustment is performed only by the liquid crystal panel 11 grayscale adjustment. If the measured temperature TL is equal to or higher than 20° C., which is the second reference temperature TB2, the light emission adjustment percentage is 85 and the grayscale adjustment percentage is 0. Namely, the display brightness control is performed only by the cold cathode tube 17 emission adjustment. If the measured temperature TL is in the range from the first reference temperature TB1 to the second reference temperature TB2, the grayscale adjustment percentage decreases stepwise from 85 to 0 and the light emission adjustment percentage increases stepwise from 0 to 85 as the temperature increases from the first reference temperature TB1 (10° C.) to the second reference temperature TB2 (20° C.)

With this configuration, the infrared radiation from the cold cathode tubes 17 is effectively controlled. The infrared radiation from the cold cathode tubes 17 decreases as the temperature of the cold cathode tubes 17 increases. Therefore, the configuration in which the cold cathode tube 17 emission adjustment percentage increases stepwise as the temperature increases from the first reference temperature TB1 to the second reference temperature TB2 can effectively restrict the infrared radiation. Such a configuration is suitable for use in a system in which the measured temperature TL measured by the temperature sensor TS is sent to the brightness controller 40 every a certain period of time.

### Seventh Embodiment

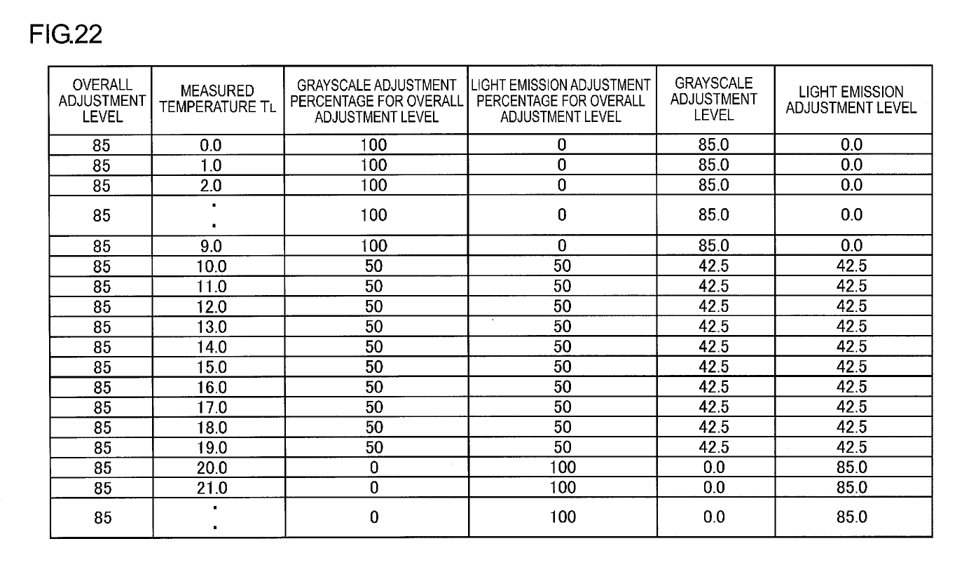

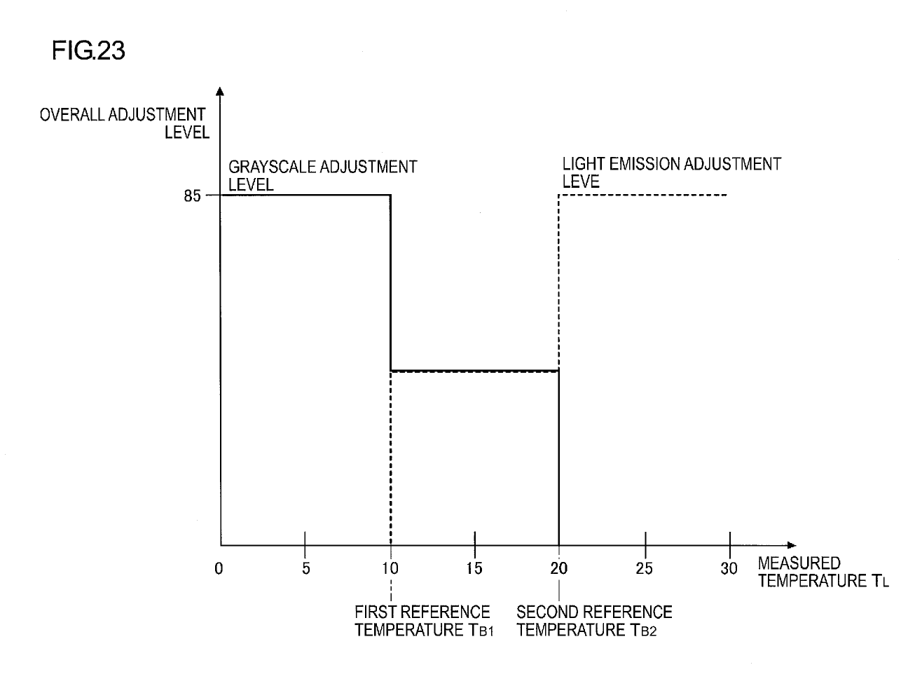

Next, the seventh embodiment of the present invention will be explained with reference to FIGS. 22 and 23. In the seventh embodiment, the LUTs have different configurations but other parts are the same as the first embodiment. The parts same as the first embodiment are indicated by the same symbols and will not be explained.

FIG. 22 is a table for providing an overview of contents of a lookup table included in the control board of the liquid crystal display device of this embodiment. FIG. 23 is a chart illustrating variations in a liquid crystal panel grayscale adjustment level and the cold cathode tube emission adjustment level with respect to the measured temperature TL.

LUTs 101 are provided for different overall brightness adjustment levels. For example, the LUT 101 in FIG. 22 is referred when the overall adjustment level is 85 (in the first column). The second column contains a list of temperatures corresponding the measured temperatures TL. According to the LUT 101, if the measured temperature TL is lower than 10° C., the grayscale adjustment percentage and the light emission adjustment percentage for the overall adjustment level are 100 and 0, respectively. If the measured temperature TL is equal to 20° C. or higher, the light emission adjustment percentage and the grayscale adjustment percentage for the overall adjustment level are 100 and 0, respectively. If the measured temperature TL is in the range from 10° C. to 20° C., the grayscale adjustment percentage and the light emission adjustment percentage for the overall adjustment level are 50 and 50, that is, they are equal.

The brightness control is performed by referring to the LUT 101. As illustrated in FIG. 23, the grayscale adjustment percentage and the light emission adjustment percentage are changed according to the measured temperature TL and the brightness is adjusted. If the measured temperature TL is lower than 10° C., which is the first reference temperature TB1, the grayscale adjustment percentage is 85 and the light emission adjustment percentage is 0. Namely, the display brightness adjustment is performed only by the grayscale adjustment of the liquid crystal panel 11. If the measured temperature TL is equal to or higher than 20° C., which is the second reference temperature TB2, the light emission adjustment percentage is 85 and the grayscale adjustment percentage is 0. Namely, the display brightness control is performed only by the light emission adjustment of the cold cathode tube 17. If the measured temperature TL is in the range from the first reference temperature TB1 to the second reference temperature TB2, the grayscale adjustment percentage and the light emission adjustment percentage for the overall adjustment level are 42.5 and 42.5, that is, the display adjustment control is performed by a combination of both.

With such a configuration, the effective brightness control can be performed by selecting the grayscale adjustment or the light emission adjustment, whichever is more effective, or the combination of both. If the measured temperature TL is in the range from the first reference temperature TB1 to the second reference temperature TB2, the brightness control is performed by the combination of the liquid crystal panel 11 grayscale adjustment and the cold cathode tube 17 emission adjustment at the same percentage. This simple configuration can provide stable brightness control and contribute to cost reduction.

### Other Embodiment

The present invention is not limited to the embodiments explained above with reference to the figures. For example, the following embodiments may be included in the technical scope of the present invention, for example.

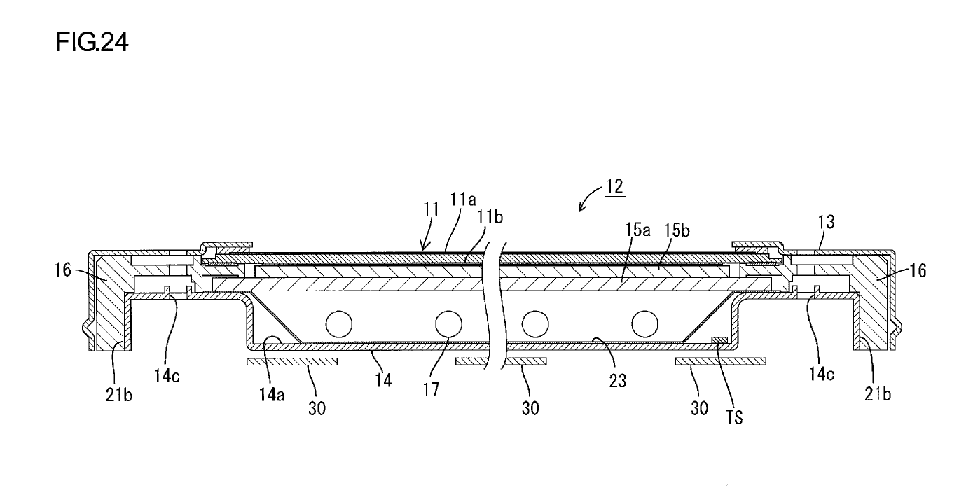

(1) In the above embodiments, the temperature sensor TS is arranged on the control board. However, the temperature sensor TS can be arranged in any other locations where a strong correlation with an average temperature of the cathode tubes, which can be heat sources due to large heat capacities thereof, can be obtained. For example, the temperature sensor TS can be arranged on an inner surface of the bottom plate of the chassis as shown in FIG. 24. Alternatively, thermocouples may be used as a temperature sensor and directly connected to the cold cathode tubes.

(2) In the above embodiments, a single temperature sensor is used for measuring the temperature of the cold cathode tubes. However, a plurality of temperature sensors may be arranged. A temperature calculated from temperatures measured by those temperature sensors by taking an average or a weighted average may be used as the measured temperature TL.

(3) In the above embodiments, the temperature sensor is arranged on the control board and measures the ambient temperature of the cold cathode tubes. However, the temperature sensor may be arranged on the chassis in a position closer to the cold cathode tubes and measure the temperature. Alternatively, the temperature sensor may be directly connected to the terminals of the cold cathode tubes and measure the temperature of the cold cathode tubes.

(4) In the above embodiments, the grayscale adjustment signal S3 and the INV output adjustment signal S4 are sent to the image control circuit and the inverter circuit, respectively, even when either of the circuit is not involved in the brightness control. However, the signal may be only sent to the circuit that is involved in the brightness control.

(5) In the above embodiments, the cold cathode tubes are used as light sources. However, other kinds of fluorescent lamps including hot cathode tubes can be used.

1. A display device comprising:
a display panel having a grayscale display function;
a fluorescent lamp configured to emit light toward the display panel;
a brightness controller configured to control display brightness by adjusting grayscale of the display panel and light emission of the fluorescent lamp; and
a temperature sensor configured to measure a temperature of the display device,
wherein the brightness controller selects a way of the display brightness control from the display panel grayscale adjustment, the fluorescent lamp emission adjustment and a combination of both based on the temperature of the display device measured by the temperature sensor.

3. The display device according to claim 1, wherein the brightness controller is configured to perform the brightness control by the display panel grayscale adjustment when the temperature of the display device is lower than a predetermined reference temperature and by the fluorescent lamp emission adjustment when the temperature of the display device is equal to the reference temperature or higher.

3. The display device according to claim 2, wherein:
the reference temperature includes a first reference temperature and a second reference temperature that is higher than the first reference temperature;
the brightness controller performs the brightness control by the display panel grayscale adjustment when the temperature of the display device is lower than the first reference temperature;
the brightness controller performs the brightness control by a combination of the display panel grayscale adjustment and the fluorescent lamp emission adjustment when the temperature of the display device is in a range from the first reference temperature to the second reference temperature; and
the brightness controller performs the brightness control by the fluorescent lamp emission adjustment when the temperature of the display device is equal to the second reference temperature or higher.

4. The display device according to claim 3, wherein:
an overall adjustment level of the display device is determined for the brightness control by the combination of the display panel grayscale adjustment and the fluorescent lamp emission adjustment when the temperature of the display device is in the range from the first reference temperature to the second reference temperature; and
a fluorescent lamp emission adjustment percentage for an overall adjustment level is smaller than a display panel grayscale adjustment percentage when the temperature of the display device is relatively closer to the first reference temperature than the second reference temperature.

5. The display device according to claim 3, wherein:
an overall adjustment level of the display device is determined for the brightness control by the combination of the display panel grayscale adjustment and the fluorescent lamp emission adjustment when the temperature of the display device is in the range from the first reference temperature to the second reference temperature; and
a display panel grayscale adjustment percentage for an overall adjustment level is smaller than a fluorescent lamp emission adjustment percentage when the temperature of the display device is relatively closer to the second reference temperature than the first reference temperature.

6. The display device according to claim 4, wherein the fluorescent lamp emission adjustment percentage for the overall adjustment level gradually increases as the temperature increases from the first reference temperature to the second reference temperature.

7. The display device according to claim 4, wherein the fluorescent lamp emission adjustment percentage for the overall adjustment level increases stepwise as the temperature increases from the first reference temperature to the second reference temperature.

8. The display device according to claim 1, wherein the temperature sensor measures at least one of a temperature of the fluorescent lamp and an ambient temperature around the fluorescent lamp.

9. The display device according to claim 1, wherein the display panel is a liquid crystal panel including liquid crystals.

10. A television receiver comprising the display device according to claim 1.
